(19) United States
(12) Patent Application Publication
(10) Pub. No.: US 2010/0198670 A1
(43) Pub. Date: Aug. 5, 2010

(54) AFFILIATE SYSTEM AND AFFILIATE DEVICE

(76) Inventor: Nobuyuki Kano, Tokyo (JP)

Correspondence Address: BIRCH STEWART KOLASCH & BIRCH, PO BOX 747, FALLS CHURCH, VA, 22040-0747, US

(21) Appl. No.: 12/670,334

(22) PCT Filed: Jul. 24, 2008
(86) PCT No.: PCT/JP2008/001983

§ 371 Date: Jan. 22, 2010

(30) Foreign Application Priority Data
Jul. 25, 2007 (JP) 2007-193200

(51) Int. Cl. G06Q 30/00; G06Q 10/00

(52) U.S. Cl. 705/14.16; 705/14.45

(57) ABSTRACT

An affiliate system in which it is possible to form customers on the initiative of advertising clients is provided. Affiliate System 1 comprises Affiliate Server 10, Advertising Client Server 21, and Advertising Client Terminal 22. These are connected with a network. Affiliate Server 10 stores a reward-payment-was-approved bit string if received a reward-payment-approval-notifying bit string from Advertising Client Server 21, stores a check-was-done bit string if received a check-notifying bit string from Advertising Client Server 21, generates a market-data bit string using the stored check-was-done bit string if received a market-data-disclosure-requesting bit string from Advertising Client Terminal 22, and sends it to Advertising Client Terminal 22.

### BACKGROUND OF THE INVENTION

1. Field of the Invention

The present invention relates to an affiliate program and in particular to the network system and the device for implementing an affiliate program.

2. Description of the Related Art

In an affiliate system, which is a network system for implementing an affiliate program, an advertising client can usually decide whether to put its advertisement in a certain site in advance.

And, as a result, it has been thought that an advertising client can maximize its sales and sales' efficiency by composing its network around the affiliate partner sites whose categories are the same as the one of the advertising client's goods and services.

Further, in an affiliate system, an advertising client can usually analyze and check the performances (such as the number of leading to advertising client site and the number of sales) of affiliate partner sites (the sites managed by affiliate partners).

And, as a result, it has been thought that an advertising client can maximize its sales and sales' efficiency by composing its network around the affiliate partner sites whose performances are good.

### [Patent Document 1] Unexamined Patent Application Publication No. 2001-202454.

### [Patent Document 2] Unexamined Patent Application Publication No. 2003-208538.

### [Patent Document 3] Unexamined Patent Application Publication No. 2007-48165.

### [Patent Document 4] Unexamined Patent Application Publication No. 2007-58387.

### SUMMARY OF THE INVENTION

However, customers' activities after purchasing goods and services (cancel, repeat purchase, and so on) have little relation to whether the customers came from the good-performance affiliate partner site because it can be thought that: the customers who browsed a bad-performance affiliate partner site prudently purchase goods and services and purchase it repeatedly at a later date, while the customers who browsed a good-performance affiliate partner site purchase goods and services on impulse and as a result cancel it at a later date.

Thus, in the network being composed depending on affiliate partner site performances, advertising clients' customers are formed on the initiative of affiliate partners, and at the time the advertising client notices, the advertising client is being surrounded by the customers not desirable for the advertising client (such as customers who cancel frequently), and there is no customer desirable for the advertising client (such as customers who purchase repeatedly) around the advertising client.

Therefore, in the traditional affiliate system, in which customers are formed on the initiative of affiliate partners (that is, advertising client's network is composed depending on the performance of affiliate partner sites), the advertising client' sales may dwindle in the long term, although the advertising client' sales may soar in the short term.

Thus, the present invention provides an affiliate system and an affiliate device that enable to compose a network in which customers are formed on the initiative of advertising clients.

According to the present invention, the above problem is solved by the following means.

### [Affiliate System]

An affiliate system comprising an affiliate device and an advertising client device; wherein said affiliate device and said advertising client device are connected with a network, and said affiliate device comprises: means for storing a reward-payment-was-approved bit string that indicates a payment of a reward was approved if received a reward-payment-approval-notifying bit string that notifies of an approval of paying a reward for an affiliate partner from said advertising client device; means for storing a check-was-done bit string that indicates a check was done with respect to said reward-payment-was-approved bit string if received a check-notifying bit string that notifies of checking with respect to said reward-payment-was-approved bit string from said advertising client device; means for generating a market-data bit string that indicates market data by using said stored check-was-done bit string if received a market-data-disclosure-requesting bit string that requests for disclosure of said market-data bit string; and means for sending said generated market-data bit string to said advertising client device.

According to the present invention, check-was-done bit strings are stored in the affiliate device with respect to each affiliate partner site and a market-data bit string generated by using the stored check-was-done bit strings is transmitted from the affiliate device to the advertising client device.

Thus, according to the present invention, using the bit string that indicates the event (cancel, repeat purchase, and so on) was occurred after approving a payment of a reward as a check-notifying bit string, it becomes possible at the advertising client device to understand the customers' activities after purchasing goods and services (cancel, repeat purchase, and so on).

Therefore, according to the present invention, advertising clients can decide whether the prospective customers viewing a certain affiliate partner site will be the customers the advertising client is seeking for and determines based on the result of the decision whether advertising client's network composition should include the affiliate partner site.

Consequently, according to the present invention, advertising clients' customers are not formed on the initiative of affiliate partners but on the initiative of advertising clients because advertising clients do not have to construct their networks depending on affiliate partner sites' performances.

In the structure of the described affiliate system, it is preferable that: said affiliate device further comprises, for a specific affiliate partner site, means for suspending or not performing at least one of an advertisement-disclosing processing, a redirect processing, and a storing processing of said reward-payment-was-approved bit string with respect to said advertising client device if received from said advertising client device a network-composition-modification-notifying bit string that notifies of excluding said specific affiliate partner site from said advertising client device's network composition based on said market-data bit string.

This structure is preferable for forming customers on the initiative of advertising clients because it is possible to exclude an affiliate partner site, even if the performances of the affiliate partner site is good, if it is decided that the prospect customers viewing the affiliate partner site will not be able to the customers the advertising client is seeking for.

### [Affiliate Device]

Further, an affiliate device connected to an advertising client device with a network, comprising: means for storing a reward-payment-was-approved bit string that indicates a payment of a reward was approved if received a reward-payment-approval-notifying bit string that notifies of an approval of paying a reward for an affiliate partner from said advertising client device; means for storing a check-was-done bit string that indicates a check was done with respect to said reward-payment-was-approved bit string if received a check-notifying bit string that notifies of checking with respect to said reward-payment-was-approved bit string from said advertising client device; means for generating a market-data bit string that indicates market data by using said stored check-was-done bit string if received a market-data-disclosure-requesting bit string that requests for disclosure of said market-data bit string; and means for sending said generated market-data bit string to said advertising client device.

According to the present invention, check-was-done bit strings are stored in the affiliate device with respect to each affiliate partner site and a market-data bit string generated by using the stored check-was-done bit strings is transmitted from the affiliate device to the advertising client device.

Thus, according to the present invention, using the bit string that indicates the event (cancel, repeat purchase, and so on) was occurred after approving a payment of a reward as a check-notifying bit string, it becomes possible at the advertising client device to understand the customers' activities after purchasing goods and services (cancel, repeat purchase, and so on).

Therefore, according to the present invention, advertising clients can decide whether the prospective customers viewing a certain affiliate partner site will be the customers the advertising client is seeking for and determines based on the result of the decision whether advertising client's network composition should include the affiliate partner site.

Consequently, according to the present invention, advertising clients' customers are not formed on the initiative of affiliate partners but on the initiative of advertising clients because advertising clients do not have to construct their networks depending on affiliate partner sites' performances.

In the structure of the described affiliate device, it is preferable to further comprise, for a specific affiliate partner site, means for suspending or not performing at least one of an advertisement-disclosing processing, a redirect processing, and a storing processing of said reward-payment-was-approved bit string with respect to said advertising client device if received from said advertising client device a network-composition-modification-notifying bit string that notifies of excluding said specific affiliate partner site from said advertising client device's network composition based on said market-data bit string.

This structure is preferable for forming customers on the initiative of advertising clients because it is possible to exclude an affiliate partner site, even if the performances of the affiliate partner site is good, if it is decided that the prospect customers viewing the affiliate partner site will not be able to the customers the advertising client is seeking for.

According to the present invention, it is possible to provide an affiliate system and an affiliate device that enable to compose a network in which customers are formed on the initiative of advertising clients.

### BRIEF DESCRIPTION OF THE DRAWINGS

FIG. 1 is a diagram illustrating the schematic structure of Affiliate System 1 according to the embodiment of the present invention.

FIG. 2A is the first diagram illustrating the schematic operation of Affiliate System 1 according to the embodiment of the present invention.

FIG. 2B is the second diagram illustrating the schematic operation of Affiliate System 1 according to the embodiment of the present invention.

FIG. 3 is the schematic diagram of Affiliate Server 10 according to the embodiment of the present invention.

FIG. 4 (a) is a diagram illustrating the schematic diagram of the affiliate partner table.

FIG. 4 (b) is a diagram illustrating the schematic structure of the affiliate partner site table.

FIG. 5 (a) is a diagram illustrating the schematic structure of the advertising client table.

FIG. 5 (b) is a diagram illustrating the schematic structure of the advertising client site table.

FIG. 5 (c) is a diagram illustrating the schematic diagram of the advertisement manuscript table.

FIG. 6 (a) is a diagram illustrating the schematic structure of the redirect session table.

FIG. 6 (b) is a diagram illustrating the schematic structure of the affiliate partner login session table.

FIG. 6 (c) is a diagram illustrating the schematic structure of the advertising client login session table.

FIG. 7 (a) is a diagram illustrating the schematic structure of the approval table.

FIG. 7 (b) is a diagram illustrating the schematic structure of the denial table.

FIG. 8 is a flowchart illustrating the affiliate-partner-registering processing.

FIG. 9 is a flowchart illustrating the advertising-client-registering processing.

FIG. 10 is a flowchart illustrating the affiliate-partner-login processing.

FIG. 11 is a flowchart illustrating the advertisement-tag-list-disclosing processing.

FIG. 12 is a flowchart illustrating the affiliate-partner-login-session-monitoring processing.

FIG. 13 is a flowchart illustrating the advertisement-list-bit-string-generating processing.

FIG. 14 is a flowchart illustrating the advertisement-tag-list-bit-string-generating processing.

FIG. 15 is a flowchart illustrating the redirect processing.

FIG. 16 is a flowchart illustrating the reward-payment-approving processing.

FIG. 17 is a flowchart illustrating the checking processing.

FIG. 18 is a flowchart illustrating the advertising-client-login processing.

FIG. 19 is a flowchart illustrating the market-data-disclosing processing.

FIG. 20 is a flowchart illustrating the network-composition-modifying processing.

FIG. 21 is a flowchart illustrating the advertising-client-login-session-monitoring processing.

### DESCRIPTION OF REFERENCE SYMBOLS

1 Affiliate System
10 Affiliate Server
21 Advertising Client Server
22 Advertising Client Terminal
31A, 32B Affiliate Partner Terminal
40 Web Server
51A, 52A, 53B, 54B Viewer Terminal
60 Base Station
70 the Internet

### DESCRIPTION OF THE PREFERRED EMBODIMENTS

The preferred embodiment of the present invention is explained below with reference to the attached drawings.

### [Schematic Structure of Affiliate System 1 According to the Embodiment]

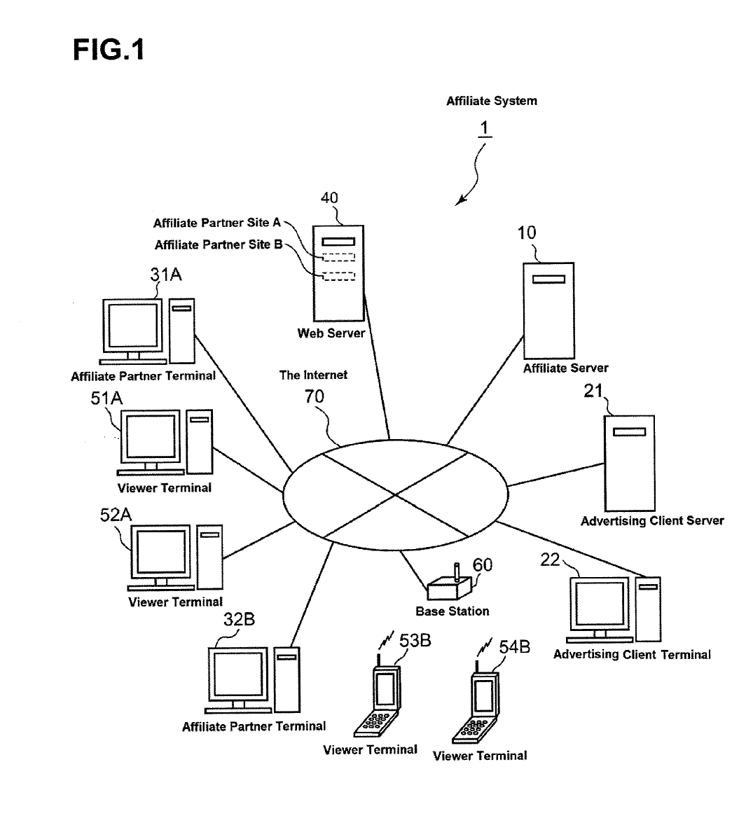

First, the schematic structure of Affiliate System 1 according to the embodiment of the present invention is described with reference to FIG. 1. FIG. 1 is a diagram illustrating the schematic structure of Affiliate System 1 according to the embodiment of the present invention.

As shown in FIG. 1, Affiliate System 1 according to the embodiment of the present invention is a network system comprising: Affiliate Server 10, Advertising Client Server 21, and Advertising Client Terminal 22. Affiliate Server 10 is an example of an affiliate device and Advertising Client Server 21 and Advertising Client Terminal 22 are examples of an advertising client device. These are connected with the Internet 70.

Affiliate System 1 further comprises Affiliate Partner Terminal 31A, 32B, Web Server 40, and Viewer Terminal 51A, 52A, 53B, 54B. Affiliate Partner Terminal 31A, 32B are terminals used by affiliate partners, Web Server 40 is an server to which Affiliate Partner Terminal 31A, 32B upload web pages that constructs affiliate partner sites, and Viewer Terminal 51A, 52A, 53B, 54B are terminals for viewing web pages uploaded to Web Server 40 with browsers. Viewer Terminal 53B, 54B are mobile computers such as cell phones or PDA which communicate with the devices on Affiliate System 1 via Base Station 60.

As described below, according to the embodiment of the present invention, check-was-done bit strings are stored in Affiliate Server 10 with respect to each affiliate partner site and a market-data bit string generated by using the stored check-was-done bit strings is transmitted from Affiliate Server 10 to Advertising Client Terminal 22.

Thus, according to the embodiment of the present invention, using the bit string that indicates an event (cancel, repeat purchase, and so on) was occurred after approving a payment of a reward as a check-notifying bit string, it becomes possible at Advertising Client Terminal 22 to understand customers' activities after purchasing goods and services (cancel, repeat purchase, and so on).

Therefore, according to the embodiment of the present invention, advertising clients can decide whether the prospective customers viewing a certain affiliate partner site will be the customers the advertising client is seeking for and determines based on the result of the decision whether advertising client's network composition should include the affiliate partner site.

Consequently, according to the embodiment of the present invention, advertising clients' customers are not formed on the initiative of affiliate partner but on the initiative of advertising client because advertising clients do not have to construct their networks depending on affiliate partner sites' performances.

For example, assume that Affiliate Partner Site A managed by Affiliate Partner Terminal 31A and Affiliate Partner Site B managed by Affiliate Partner Terminal 32B exist. Further assume that Affiliate Partner Site A is viewed frequently by Viewer Terminal 51, 52A and Affiliate Partner Site B is viewed frequently by Viewer Terminal 53B, 54B. In this case, the computer user viewing Affiliate Partner Site A with Viewer Terminal 51A, the computer user viewing Affiliate Partner Site A with Viewer Terminal 52A, the computer user viewing Affiliate Partner Site B with Viewer Terminal 53B, and the computer user viewing Affiliate Partner Site B with Viewer Terminal 54B are the prospect customers of Advertising Client Server 21 in the Internet 70.

Now assume that only the computer user of Viewer Terminal 51A purchases an advertising client's goods or services on Advertising Client Server 21 after coming from Affiliate Partner Site A, while both computer users of Viewer Terminal 53B and 54B purchase the advertising client's goods or services on Advertising Client Server 21 after coming from Affiliate Partner Site B.

However, assume that the computer user of Viewer Terminal 51A who came from Affiliate Partner Site A to Advertising Client Server 21 prudently purchased the goods or services and is being satisfied, while the computer users of Viewer Terminal 53B, 54B who came from Affiliate Partner Site B to Advertising Client Server 21 purchased the goods or services on impulse, regretted it, and cancelled it after the purchase.

In this case, although Affiliate Partner Site A is regarded as a bad-performance site and Affiliate Partner Site B is regarded as a good-performance site, however, the prospect customers around Affiliate Partner Site A are considered the prudent layer, who prudently consider and purchase repeatedly, and the prospect customers around Affiliate Partner Site B are considered the impulse layer, who purchase goods and services on impulse and cancel at a later date.

Therefore, it is preferable for the advertising client to make contracts with the prospect customers around Affiliate Partner Site A and not to make contracts with the prospect customers of Affiliate Partner Site B.

In this case, according to the embodiment, it enables at Advertising Client Terminal 22 to understand that: the prospect customers around Affiliate Partner Site A are the prudent layer, who purchase repeatedly, and the prospect customers around Affiliate Partner Site B are the impulse layer by confirming how many check-was-done bit strings are stored with respect to each affiliate partner site.

Furthermore, the advertising client can exclude Affiliate Partner Site B from the network composition of Advertising Client Server 21 based on the understanding, and, for example, deny the access from Affiliate Partner Site B to Advertising Client Server 21.

The explanation of Affiliate System 1 according to the embodiment of the present invention is continued below, where Affiliate Partner Terminal 31A, 32B are labeled as Affiliate Partner Terminal 30 and Viewer Terminal 51A, 52A, 53B, 54B are labeled as Viewer Terminal 50 to make understanding easy.

### [Schematic Operation of Affiliate System 1 According to the Embodiment]

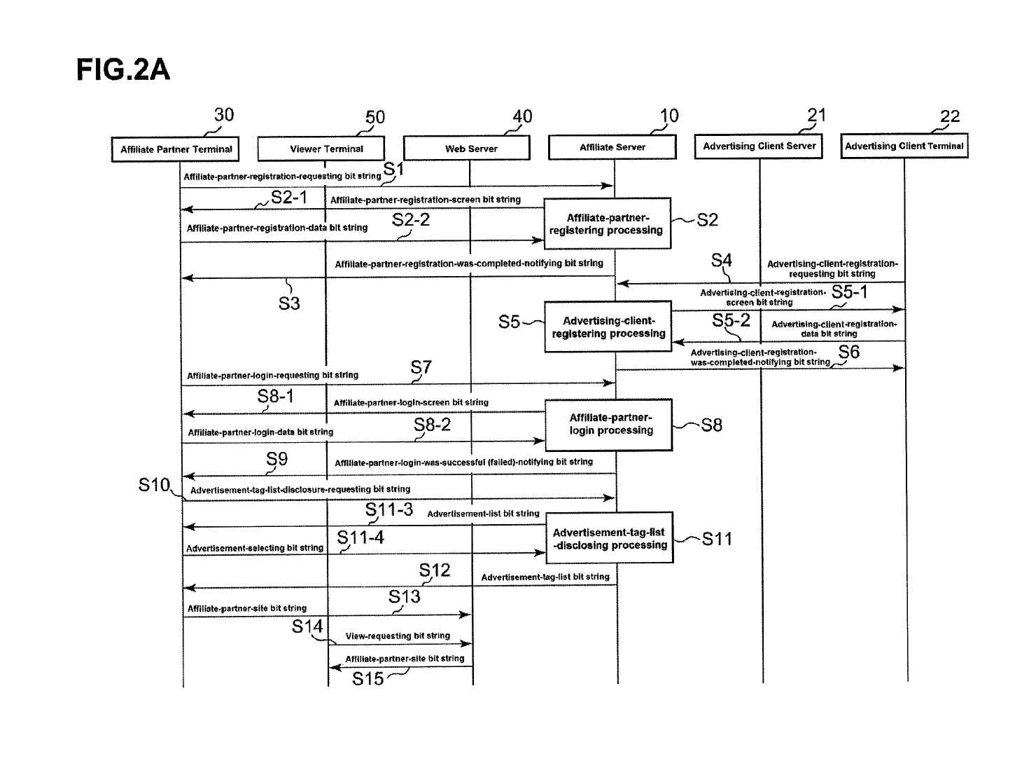

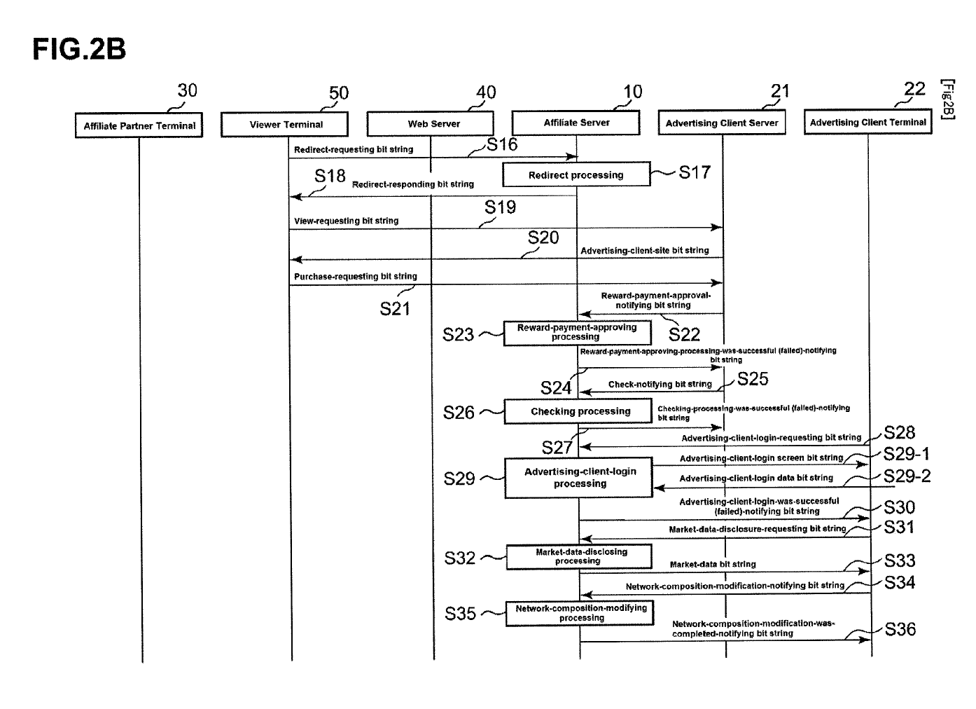

Next, the schematic operation of Affiliate System 1 according to the embodiment of the present invention is described with reference to FIG. 2. FIG. 2A is the first diagram illustrating the schematic operation of Affiliate System 1 according to the embodiment of the present invention. FIG. 2B is the second diagram illustrating the schematic operation of Affiliate System 1 according to the embodiment of the present invention, illustrating the rest of the schematic operation of FIG. 2A.

### [Step S1: Affiliate-Partner-Registration-Requesting Bit String]

First, Affiliate Partner Terminal 30 sends an affiliate-partner-registration-requesting bit string to Affiliate Server 10 (step S1). The affiliate-partner-registration-requesting bit string is a bit string that requests for registering the computer user who is using Affiliate Partner Terminal 30 as an affiliate-partner and registering the web page (managed by the computer user who uses Affiliate Partner Terminal 30) of Web Server 40 as an affiliate partner site.

### [Step S2: Affiliate-Partner-Registering Processing]

Affiliate Server 10, if received an affiliate-partner-registration-requesting bit string (see step S1), starts an affiliate-partner-registering processing (step S2). The affiliate-partner-registering processing is a processing for registering the computer user who uses Affiliate Partner Terminal 30 as an affiliate-partner and registering the web page (managed by the computer user who uses Affiliate Partner Terminal 30) of Web Server 40 as an affiliate partner site.

### [Step S3: Affiliate-Partner-Registration-was-Completed-Notifying Bit String]

Affiliate Server 10, after the affiliate-partner-registering processing (see step S2), sends an affiliate-partner-registration-was-completed-notifying bit string to Affiliate Partner Terminal 30 (step S3). The affiliate-partner-registration-was-completed notifying bit string is a bit string that notifies an affiliate-partner-registering processing was completed.

### [Step S4: Advertising-Client-Registration-Requesting Bit String]

Next, Advertising Client Terminal 22 sends an advertising-client-registration-requesting bit string to Affiliate Server 10 (step S4). The advertising-client-registration-requesting bit string is a bit string that requests for registering the computer user who uses Advertising Client Terminal 22 as an advertising client and registering the web page (managed by the computer user who uses Advertising Client Terminal 22) of Advertising Client Server 21 as an advertising client site.

### [Step S5: Advertising-Client-Registering Processing]

Affiliate Server 10, if received an advertising-client-registration-requesting bit string (see step S4), starts an advertising-client-registering processing (step S5). The advertising-client-registering processing is a processing for registering the computer user who uses Advertising Client Terminal 22 as an advertising client and registering the web page (managed by the computer user who uses Advertising Client Terminal 22) of Advertising Client Server 21 as an advertising client site.

### [Step S6: Advertising-Client-Registration-was-Completed-Notifying Bit String]

Affiliate Server 10, after the advertising-client-registering processing (see step S5), sends an advertising-client-registration-was-completed-notifying bit string to Advertising Client Terminal 22 (step S6). The advertising-client-registration-was-completed-notifying bit string is a bit string that notifies the advertising-client-registering processing was completed.

### [Step S7: Affiliate-Partner-Login-Requesting Bit String]

Next, Affiliate Partner Terminal 30 sends an affiliate-partner-login-requesting bit string to Affiliate Server 10 (step S7). The affiliate-partner-login-requesting bit string is a bit string that requests for accessing to Affiliate Server 10 as an affiliate partner.

### [Step S8: Affiliate-Partner-Login Processing]

Affiliate Server 10, if received an affiliate-partner-login-requesting bit string (see step S7), starts an affiliate-partner-login processing (step S8). The affiliate-partner-login processing is a processing for deciding whether to permit Affiliate Partner Terminal 30 to access as an affiliate partner.

### [Step S9: Affiliate-Partner-Login-was-Successful (Failed)-Notifying Bit String]

Affiliate Server 10, after the affiliate-partner-login processing (see step S8), sends an affiliate-partner-login-was-successful (failed)-notifying bit string to Affiliate Partner Terminal 30 (step S9). The affiliate-partner-login-was-successful (failed)-notifying bit string is a bit string that notifies the login as an affiliate partner was successful (failed).

### [Step S10: Advertisement-Tag-List-Disclosure-Requesting Bit String]

Next, Affiliate Partner Terminal 30 sends an advertisement-tag-list-disclosure-requesting bit string to Affiliate Server 10 (step S10). The advertisement-tag-list-disclosure-requesting bit string is a bit string that requests for disclosure a list of advertisement tags. The tags are paste-able to affiliate partner sites registered in Affiliate Server 10. Note that, as described below, the advertisement-tag-list-disclosure-requesting bit string includes an affiliate partner site ID and an affiliate partner login session ID.

### [Step S11: Advertisement-Tag-List-Disclosing Processing]

Affiliate Server 10, if received an advertisement-tag-list-disclosure-requesting bit string (see step S10), starts the advertisement-tag-list-disclosing processing (step S11). The advertisement-tag-list-disclosing processing is a processing for disclosing a list of advertisement tags that are paste-able to the affiliate partner site which is an affiliate partner site of affiliate partner sites registered in Affiliate Server 10 and is managed by the affiliate partner who sent the advertisement-tag-list-disclosure-requesting bit string. The advertisement-tag-list-disclosing processing is one example of an advertisement-disclosing processing.

### [Step S12: Advertisement-Tag-List Bit String]

Affiliate Server 10, after the advertisement-tag-list-disclosing processing (see step S11), sends an advertisement-tag-list bit string to Affiliate Partner Terminal 30 (step S12). The advertisement-tag-list bit string is a bit string that constructs the web page displaying a list of advertisement tags.

### [Step S13: Affiliate-Partner-Site Bit String]

Next, Affiliate Partner Terminal 30 sends an affiliate-partner-site bit string to Web Server 40 (step S13). The affiliate-partner-site bit string is a bit string that constructs an affiliate partner site to which an advertisement tag is being pasted. In this way, an affiliate partner site is uploaded to Web Server 40.

### [Step S14: View-Requesting Bit String]

Next, Viewer Terminal 50 sends a view-requesting bit string to Web Server 40 (step S14). The view-requesting bit string is a bit string that requests for viewing an affiliate partner site.

### [Step S15: Affiliate-Partner-Site Bit String]

Next, Web Server 40 sends an affiliate-partner-site bit string that was uploaded from Affiliate Partner Terminal 30 to Viewer Terminal 50 (step S15). This enables Viewer Terminal 50 to view an affiliate partner site.

### [Step S16: Redirect-Requesting Bit String]

Next, Viewer Terminal 50 sends a redirect-requesting bit string to Affiliate Server 10 (step S16). The redirect-requesting bit string is a bit string that requests for redirecting to Advertising Client Server 21. The redirect-requesting bit string is transmitted from Viewer Terminal 50 to Affiliate Server 10 if a selecting processing, which is a processing to select the area constructed with an advertisement tag in an affiliate partner site, was done in Viewer Terminal 50. A click is an example of the selecting processing.

Note that, as described below, the redirect-requesting bit string includes an affiliate partner site ID, an advertising client site ID, and an advertisement manuscript ID.

### [Step S17: Redirect Processing]

Affiliate Server 10, if received a redirect-requesting bit string, starts the redirect processing (step S17).

### [Step S18: Redirect-Responding Bit String]

Affiliate Server 10, after the redirect processing (see step S17), sends a redirect-responding bit string to Viewer Terminal 50 (step S18).

### [Step S19: View-Requesting Bit String]

Next, Viewer Terminal 50 sends a view-requesting bit string to Advertising Client Server 21 based on the redirect-responding bit string received from Affiliate Server 10 (step S19). The view-requesting bit string is a bit string that requests for viewing an advertising client site.

### [Step S20: Advertising-Client-Site Bit String]

Next, Advertising Client Server 21 sends an advertising-client-site bit string to Viewer Terminal 50 (step S20). The advertising-client-site bit string is a bit string that constructs an advertising client site. This enables Viewer Terminal 50 to view an advertising client site. Note that advertising client sites are made as web pages in which advertising clients' goods and services are displayed and it is possible at Viewer Terminal 50 to purchase the advertising clients' goods and services.

### [Step S21: Purchase-Requesting Bit String]

Next, Viewer Terminal 50 sends a purchase-requesting bit string to Advertising Client Server 21 (step S21). The purchase-requesting bit string is a bit string that requests for purchasing advertising client's goods and services displayed in an advertising client site. Advertising Client Server 21, if received a purchase-requesting bit string, executes a given purchase processing.

### [Step S22: Reward-Payment-Approval-Notifying Bit String]

Next, Advertising Client Server 21 sends a reward-payment-approval-notifying bit string to Affiliate Server 10 (step S22). The reward-payment-approval-notifying bit string is a bit string that notifies of an approval of paying a reward for an affiliate partner. Note that, as described below, a reward-payment-approval-notifying bit string includes a redirect session ID and an advertising client site key.

### [Step S23: Reward-Payment-Approving Processing]

Affiliate Server 10, if received a reward-payment-approval-notifying bit string (see step S22), starts a reward-payment-approving processing (step S23). The reward-payment-approving processing is a processing for storing a reward-payment-was-approved bit string. The reward-payment-was-approved bit string is a bit string that indicates a payment of a reward was approved.

### [Step S24: Reward-Payment-Approving-Processing-was-Successful (Failed)-Notifying Bit String]

Affiliate Server 10, after the reward-payment-approving processing (see step S23), sends a reward-payment-approving-processing-was-successful (failed)-notifying bit string to Advertising Client Server 21 (step S24). The reward-payment-approving-processing-was-successful (failed)-notifying bit string is a bit string that notifies the reward-payment-approving processing was successful (failed).

### [Step S25: Check-Notifying Bit String]

Next, Advertising Client Server 21 sends a check-notifying bit string to Affiliate Server 10 (step S25). The check-notifying bit string is a bit string that notifies of checking with respect to a reward-payment-was-approved bit string. The check-notifying bit string is transmitted from Advertising Client Server 21 to Affiliate Server 10 if an event defined arbitrarily by an advertising client (cancel, repeat purchase, and so on) occurs after the advertising client approved a payment for a reward. Note that, as described below, the check-notifying bit string includes a redirect session ID and an advertising client site key.

### [Step S26: Checking Processing]

Affiliate Server 10, if received a check-notifying bit string, starts the checking processing (step S26). The checking processing is a processing for storing a check-was-done bit string, which is a bit string that indicates a check was done with respect to a reward-payment-was-approved bit string.

### [Step S27: Checking-Processing-was-Successful (Failed)-Notifying Bit String]

Affiliate Server 10, after the checking processing (see step S26), sends a checking-processing-was-successful (failed)-notifying bit string to Advertising Client Server 21. The checking-processing-was-successful (failed)-notifying bit string is a bit string that indicates a checking-processing was successful (failed).

### [Step S28: Advertising-Client-Login-Requesting Bit String]

Next, Advertising Client Terminal 22 sends an advertising-client-login-requesting bit string to Affiliate Server 10 (step S28). The advertising-client-login-requesting bit string is a bit string that requests for accessing Affiliate Server 10 as an advertising client.

### [Step S29: Advertising-Client-Login Processing]

Affiliate Server 10, if received an advertising-client-login-requesting bit string (see step S28), starts the advertising-login processing (step S29). The advertising-client-login processing is a processing to deciding whether to permit Advertising Client Terminal 22 to access as an advertising client.

### [Step S30: Advertising-Client-Login-was-Successful (Failed)-Notifying Bit String]

Affiliate Server 10, after the advertising-client-login processing (see step S29), sends an advertising-client-login-was-successful (failed)-notifying bit string to Advertising Client Terminal 22 (step S30). The advertising-client-login-was-successful (failed)-notifying bit string is a bit string that notifies the login as advertising client was successful (failed).

### [Step S31: Market-Data-Disclosure-Requesting Bit String]

Next, Advertising Client Terminal 22 sends a market-data-disclosure-requesting bit string to Affiliate Server 10. The market-data-disclosure-requesting bit string is a bit string that requests for disclosure of a market-data bit string. The market-data bit string according to the present embodiment is a bit string generated by using the value that gotten by counting how many check-was-done bit strings are stored with respect to each affiliate partner site. Note that, as described below, a market-data-disclosure-requesting bit string includes an advertising client login session ID.

### [Step S32: Market-Data-Disclosing Processing]

Affiliate Server 10, if a market-data-disclosure-requesting bit string (see step S31), starts the market-data-disclosing processing (step S32). The market-data-disclosing processing is a processing for disclosing a market-data bit string.

### [Step S33: Market-Data Bit String]

Affiliate Server 10, after the market-data-disclosing processing (see step S32), sends a market-data bit string to Advertising Client Terminal 22 (step S33).

### [Step S34: Network-Composition-Modification-Notifying Bit String]

Next, Advertising Client Terminal 22 sends a network-composition-modification-notifying bit string to Affiliate Server 10 based on a market-data bit string. The network-composition-modification-notifying bit string is a bit string that notifies of excluding a specific affiliate partner site from the network composition of Advertising Client Server 21. Note that, as described below, a network-composition-modification-notifying bit string includes an advertising client login session ID and an affiliate partner site key.

### [Step S35: Network-Composition-Modifying Processing]

Affiliate Server 10, if received a network-composition-modification-notifying bit string (see step S34), starts the network-composition-modifying processing (step S35). The network-composition-modifying processing is a processing for excluding a specific affiliate partner site from the network composition of Advertising Client Server 21. If an affiliate partner site was excluded from the network composition of Advertising Client Server 21, afterward, for the affiliate partner site, the advertisement-tag-list-disclosing processing, the redirect processing, and the storing processing of the reward-payment-was-approved-bit string will not be performed or will be suspended with respect to all of advertising client sites of Advertising Client Server 21.

### [Step S36: Network-Composition-Modification-was-Completed-Notifying Bit String]

Affiliate Server 10, after the network-composition-modifying processing (see step S35), sends a network-composition-modification-was-completed-notifying bit string to Advertising Client Terminal 22 (step S36). The network-composition-modification-was-completed-notifying bit string is a bit string that notifies of a network-composition-modification was completed.

### [Schematic Structure of Affiliate Server 10 According to the Embodiment]

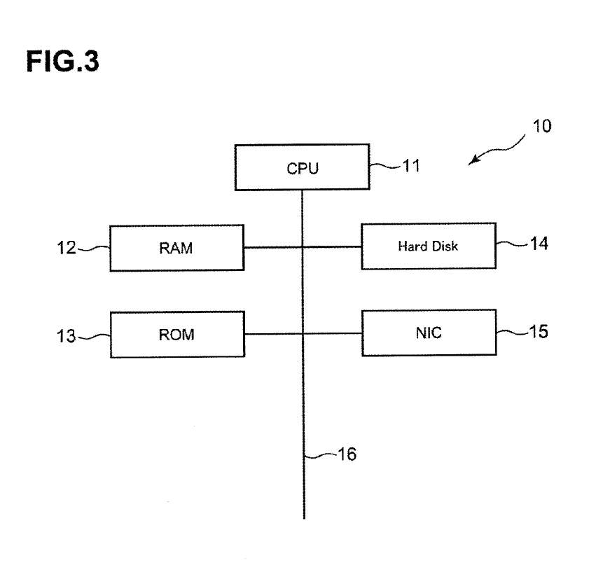

Next, the schematic structure of Affiliate Server 10 according to the embodiment of the present invention is described with reference to FIG. 3. FIG. 3 is the schematic diagram of Affiliate Server 10 according to the embodiment of the present invention.

As shown in FIG. 3, Affiliate Server 10 according to the embodiment of the present invention is a server computer comprising: CPU 11, RAM 12, ROM 13 where such as a boot program is being storing, Hard Disk 14, which is an example of a storing means, Network Interface Card 15 (NIC 15) connected to the Internet 70, and BUS 16 connecting these.

In Affiliate Server 10, reading out programs stored in Hard Disk 14 to RAM 12 and executing these by CPU 11, the above described processing is executed. Various bit strings processed by CPU 11 are stored in table form.

### [Schematic Structures of the Tables]

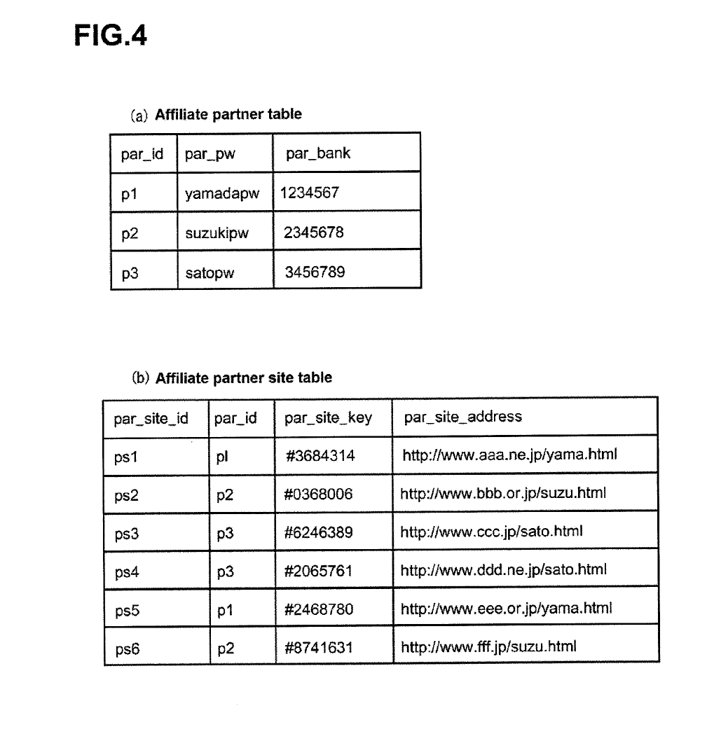

Next, the schematic structures of the tables stored in Hard Disk 14 of Affiliate Server 10 according to the embodiment of the present invention are described with reference to from FIG. 4 to FIG. 7. FIG. 4 to 7 are diagrams illustrating tables, in which bit strings are stored, displayed on the screen connected to Affiliate Server 10.

### (Affiliate Partner Table)

FIG. 4 (a) is a diagram illustrating the schematic diagram of the affiliate partner table. In the affiliate partner table, the bit strings regarding affiliate partners are stored.

The “par_id” field

In the “par_id” field, affiliate partner IDs are stored. The affiliate partner ID is a bit string that identifies an affiliate-partner.

The “par_pw” field

In the “par_pw” field, affiliate partner passwords are stored. The affiliate partner password is a bit string that is needed when affiliate Partner Terminal 30 logins to Affiliate Server 10.

The “par_bank” field

In the “par_bank” field, the bit strings that indicates affiliate-partners' bank account numbers are stored. Affiliate-partners are paid based on the bit strings that indicate affiliate partners' bank account numbers if reward-payment-was-approved bit strings are stored in Affiliate Server 10.

### (Affiliate Partner Site Table)

FIG. 4 (b) is a diagram illustrating the schematic structure of the affiliate partner site table. In the affiliate partner site table, the bit strings regarding affiliate partner sites (web pages uploaded to Web Server 40) are stored.

The “par_site_id” field

In the “par_site_id” field, affiliate site IDs are stored. The affiliate site ID is a bit string that identifies an affiliate partner site.

The “par_id” field

In the “par_id” field, affiliate partner IDs of the affiliate partners who manage the affiliate partner sites identified by the affiliate partner site IDs of the “par_site_id” field are stored.

The “par_site_key” field

In the “par_site_key” field, affiliate partner site keys are stored. The affiliate partner site key is a bit string that identifies an affiliate partner site but is different from an affiliate partner site ID.

For enabling to exclude a specific affiliate partner site at Advertising Client Terminal 22, it is necessary to enable to identify an affiliate partner site at Advertising Client Terminal 22.

However, if an affiliate partner site ID is disclosed to Advertising Client Terminal 22 as the bit string for identifying an affiliate partner site, a part of information to be disclosed only to an affiliate partner is disclosed to Advertising Client Terminal 22. As a result, it become impossible to construct an affiliate system in which the information to be disclosed only to affiliate partners is not disclosed to advertising clients.

Therefore, Affiliate System 1 according to the embodiment of the present invention discloses affiliate partner site keys rather than affiliate partner site IDs to Advertising Client Terminal 22.

Thus, in Affiliate System 1 according to the embodiment of the present invention, it is possible to exclude a specific affiliate partner site from Advertising Client Terminal 22 without disclosing the information to be disclosed only to affiliate partners to Advertising Client Terminal 22.

The “par_site_address” field

In the “par_site_address” field, affiliate partner site addresses are stored. The affiliate partner site address is a bit string that indicates address of an affiliate partner site in the Internet 70.

### (Advertising Client Table)

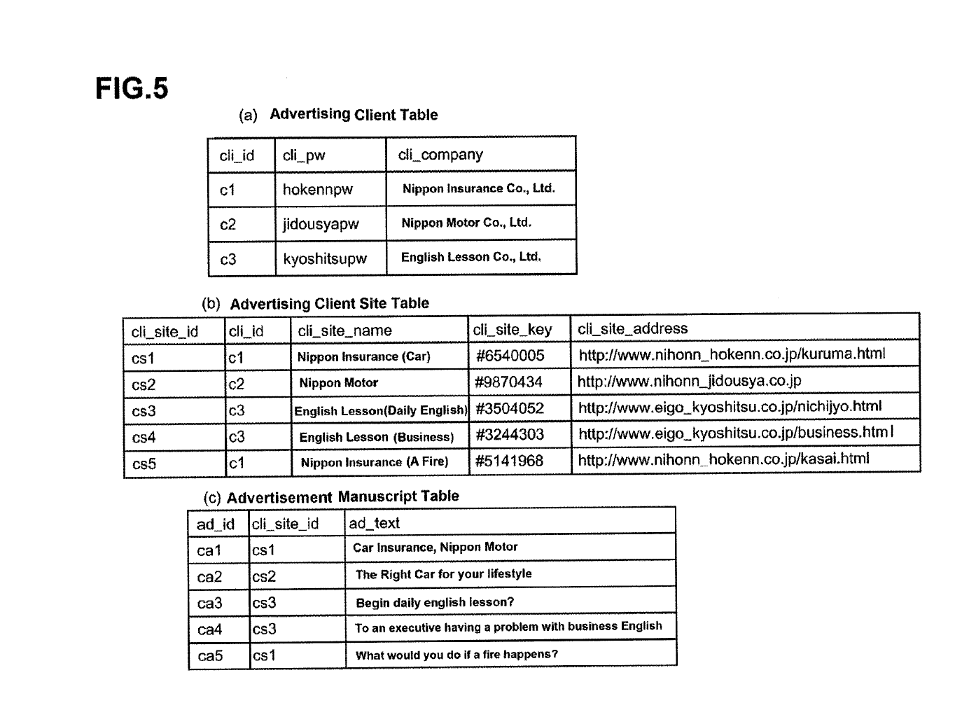

FIG. 5 (a) is a diagram illustrating the schematic structure of the advertising client table. In the advertising client table, the bit strings regarding advertising clients are stored.

The “cli_id” field

In the “cli_id” field, advertising client IDs are stored. The Advertising Client ID is a bit string that identifies an advertising client.

The “cli_pw” field

In the “cli_pw” field, advertising client passwords are stored. The advertising client password is a bit string that is needed when Advertising Client Terminal 22 logins to Affiliate Server 10.

The “cli_company” field

In the “cli_company” field, advertising client names are stored. The advertising client name is a bit string that indicates the name of an advertising client.

### (Advertising Client Site Table)

FIG. 5 (b) is a diagram illustrating the schematic structure of the advertising client site table. In the advertising client site table, the bit strings regarding advertising client sites (web pages uploaded to Advertising Client Server 21) are stored.

The “cli_site_id” field

In the “cli_site_id” field, advertising client site IDs are stored. The advertising client site ID is a bit string that identifies an advertising client site.

The “cli_id” field

In the “cli_id” field, advertising client IDs of the advertising clients who manage the advertising client sites identified by the advertising client site IDs of the “cli_site_id” field are stored.

The “cli_site_name” field

In the “cli_site_name” field, advertising client site names are stored. The advertising client site name is a bit string that indicates the name of an advertising client site.

The “cli_site_key” field

In the “cli_site_key” field, advertising client site keys are stored. The advertising client site key is a bit string that identifies an advertising client site but is deferent from an advertising client site ID.

As described above, from Advertising Client Server 21 to Affiliate Server 10, reward-payment-approval-notifying bit strings are transmitted. However, the reward-payment-approval-notifying bit string is the bit string that notifies of an approval of paying a reward for an affiliate partner. As a consequence, if a reward-payment-approval-notifying bit string is transmitted from the device other than Advertising Client Server 21 to Affiliate Server 10 fraudulently and received, a fraud such as that a reward is paid to an affiliate partner despite the advertising client has not approved it becomes possible.

Therefore, Affiliate System 1 according to the embodiment of the present invention includes an advertising client site key in a reward-payment-approval-notifying bit string and decides based on the advertising client site key whether the reward-payment-approval-notifying bit string is the thing that transmitted from Advertising Client Server 21 when approving a payment of a reward.

Thus, Affiliate System 1 according to the embodiment of the present invention can prevent such a fraud that a reward is paid to an affiliate partner despite the advertising client has not approved it.

The “cli_site_address” field

In the “cli_site_address” field, advertising client site addresses are stored. The advertising client site address is a bit string that indicates advertising client site's address in the Internet 70.

### (Advertisement Manuscript Table)

FIG. 5 (c) is a diagram illustrating the schematic diagram of the advertisement manuscript table. In the advertisement manuscript table, the bit strings regarding advertisement manuscript texts, which are displayable in affiliate partner sites (web pages uploaded to Web Server 40), are stored.

The “ad_id” field

In the “ad_id” field, advertisement manuscript IDs are stored. The advertisement manuscript ID is a bit string that identifies an advertisement manuscript text, which is displayable in affiliate partner sites.

The “cli_site_id” field

In the “cli_site_id” field, advertising client site IDs of the advertising client sites that display the goods and services advertised by the advertisement manuscript texts identified by the advertisement manuscript IDs of the “ad_id” field are stored.

The “ad_text” field

In the “ad_text” field, advertisement manuscript texts are stored. The advertisement manuscript text is a bit string that indicates the letters displayable in affiliate partner sites.

### (Redirect Session Table)

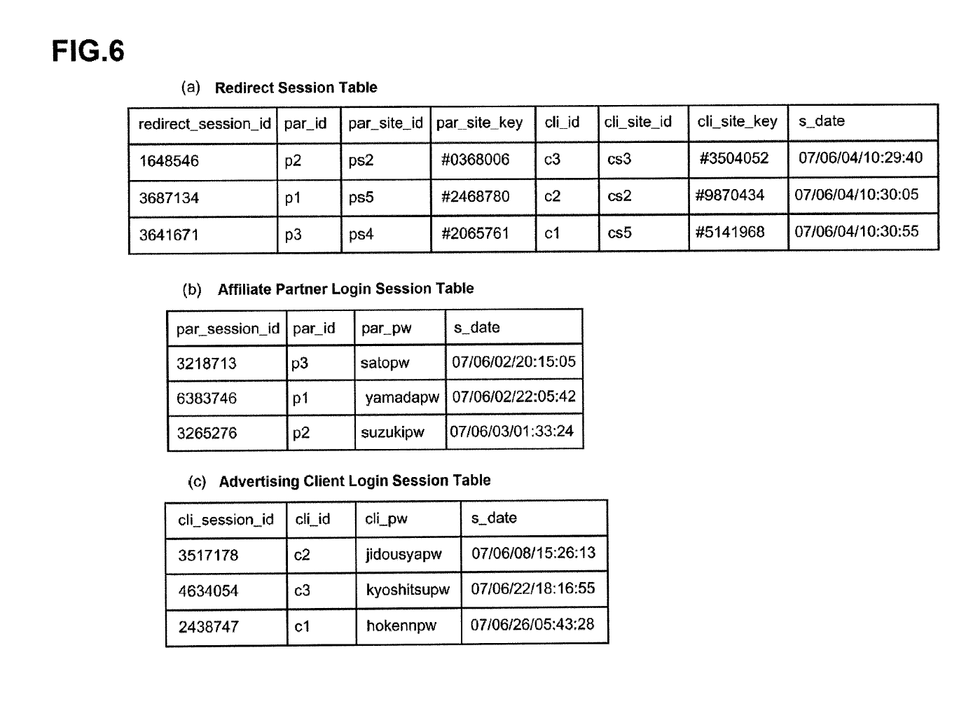

FIG. 6 (a) is a diagram illustrating the schematic structure of the redirect session table. The redirect session table stores the bit strings regarding the redirect processing (see step S17).

The “redirect_session_id” field

In the “redirect_session_id” field, redirect session IDs are stored. The redirect session ID is a bit string that identifies the session of a redirect processing.

The “par_id” field

In the “par_id” field, affiliate partner IDs of the affiliate partners who manage the affiliate partner sites that were viewed by Viewer Terminal 50 are stored.

The “par_site_id” field

In the “par_site_id” field, affiliate partner site IDs of the affiliate partner sites that were viewed by Viewer Terminal 50 are stored.

The “par_site_key” field

In the “par_site_key” field, affiliate partner site keys of the affiliate partner sites that were viewed by Viewer Terminal 50 are stored.

The “chid” field

In the “chid” field, advertising client IDs of the advertising clients who manage the advertising client sites that Viewer Terminal 50 is going to view passing through affiliate partner sites are stored.

The “cli_site_id” field

In the “cli_siteid” field, advertising client site IDs of the advertising client sites that Viewer Terminal 50 is going to view passing through affiliate partner sites are stored.

The “cli_site_key” field

In the “cli_site_key” field, advertising client site keys of the advertising client sites that Viewer Terminal 50 is going to view passing through affiliate partner sites are stored.

The “s_date” field

In the “s_date” field, bit strings that indicate the date and time at which the redirect session IDs were generated are stored.

### (Affiliate Partner Login Session Table)

FIG. 6 (b) is a diagram illustrating the schematic structure of the affiliate partner login session table. In the affiliate partner login session table, the bit strings regarding the affiliate-partner-login processing are stored (see step S8).

The “par_session_id” field

In the “par_session_id” field, affiliate partner login session IDs are stored. The affiliate partner login session ID is a bit string that identifies the session regarding the affiliate-partner-login processing (see step S8).

The “par_id” field

In the “par_id” field, affiliate partner IDs of the affiliate partners who logged into Affiliate Server 10 are stored.

The “par_pw” field

In the “par_pw” field, affiliate partner passwords of the affiliate partners who logged into Affiliate Server 10 are stored.

The “s_date” field

In the “s_date” field, the date and time at which affiliate partner login session IDs were generated are stored.

### (Advertising Client Login Session Table)

FIG. 6 (c) is a diagram illustrating the schematic structure of the advertising client login session table. In the advertising client login session table, the bit strings regarding the advertising-client-login processing are stored (see step S29).

The “cli_session_id” field

In the “cli_session_id” field, advertising client login session IDs are stored. The advertising client login session ID is a bit string that identifies the session regarding the advertising-client-login processing (see step S29).

The “chid” field

In the “cli_id” field, advertising client IDs of the advertising clients who logged into Affiliate Server 10 are stored.

The “cli_pw” field

In the “cli_pw” field, advertising client passwords of the advertising clients who logged into Affiliate Server 10 are stored.

The “s_date” field

In the “s_date” field, the bit strings that indicate the date and time at which advertising client login session IDs were generated are stored.

### (Approval Table)

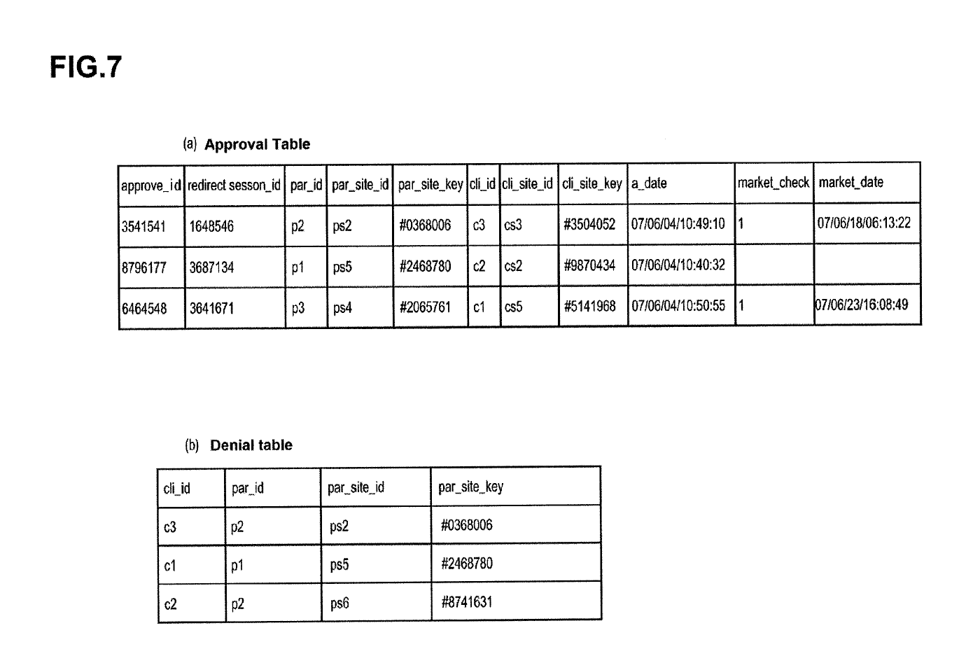

FIG. 7 (a) is a diagram illustrating the schematic structure of the approval table. In the approval table, the bit strings regarding reward payment approval are stored.

The “approve_id” field

In the “approve_id” field, approval IDs are stored. The approval ID is one example of the reward-payment-was-approved bit string, which indicates that a payment of a reward for an affiliate partner was approved.

The “redirect_session_id” field

In the “redirect_session_id” field, redirect session IDs of the session of the redirect processing with respect to which a payment of a reward was approved are stored.

The “par_id” filed

In the “par_id” filed, affiliate partner IDs of the affiliate partners who manage the affiliate partner sites that were viewed by Viewer Terminal 50 are stored regarding the session of the redirect processing with respect to which a payment of a reward was approved.

The “par_site_id” filed

In the “par_site_id” filed, affiliate partner site IDs of the affiliate partner sites that were viewed by Viewer Terminal 50 are stored regarding the session of the redirect processing with respect to which a payment of a reward was approved.

The “par_site_key” filed

In the “par_site_key” filed, affiliate partner site keys of the affiliate partner sites that were viewed by Viewer Terminal 50 regarding the session of the redirect processing with respect to which a payment of a reward was approved are stored.

The “dud” field

In the “chid” field, advertising client IDs of the advertising clients who manage the advertising client sites that Viewer Terminal 50 viewed passing through affiliate partner sites regarding the session of the redirect processing with respect to which a payment of a reward was approved are stored.

The “cli_site_id” field

In the “cli_site_id” field, advertising client site IDs of the advertising client site that were viewed by Viewer Terminal 50 passing through affiliate partner sites are stored regarding the session of redirect processing with respect to which a payment of a reward was approved.

The “cli_site_key” field

In the “cli_site_key” field, advertising client site keys of the advertising client sites that were viewed by Viewer Terminal 50 passing through affiliate partner sites regarding the session of redirect processing with respect to which a payment of a reward was approved are stored.

The “a_date” field

In the “a_date” field, the bit strings that indicate the date and time at which the approval IDs were generated are stored.

The “market_check” field

In the “market_check” field, check-was-done bit strings are stored. The present embodiment uses the bit string “1” as the check-was-done bit string. Note that, as described below, the present invention labels 1-bit as “a bit string” as well as more than 2-bits.

The “market_date” field

In the “market_date” field, the bit strings that indicate the date and time at which the check-was-done bit strings are received from Advertising Client Server 21 are stored.

### (Denial Table)

FIG. 7 (b) is a diagram illustrating the schematic structure of the denial table. In the denial table, the bit strings regarding network composition modification are stored.

The “cli_id” field

In the “cli_id” field, advertising client IDs of the advertising clients who sent network-composition-modification-notifying bit strings (see step S34) from Advertising Client Terminal 22 are stored.

The “par_id” field

In the “par_id” field, affiliate partner IDs of the affiliate partners who manage the affiliate partner sites that were notified of exclusion by a network-composition-modification-notifying bit string are stored (see step 34).

The “par_site_id” field

In the “par_site_id” filed, affiliate partner site IDs of the affiliate partner sites that were notified of exclusion by a network-composition-modification-notifying bit string are stored (see step S34).

The “par_site_key” field

In the “par_site_key” field, affiliate partner site keys of the affiliate partner sites that were notified of exclusion by a network-composition-modification-notifying bit string are stored (see step S34).

[Schematic operation of Affiliate Server 10 according to the embodiment]

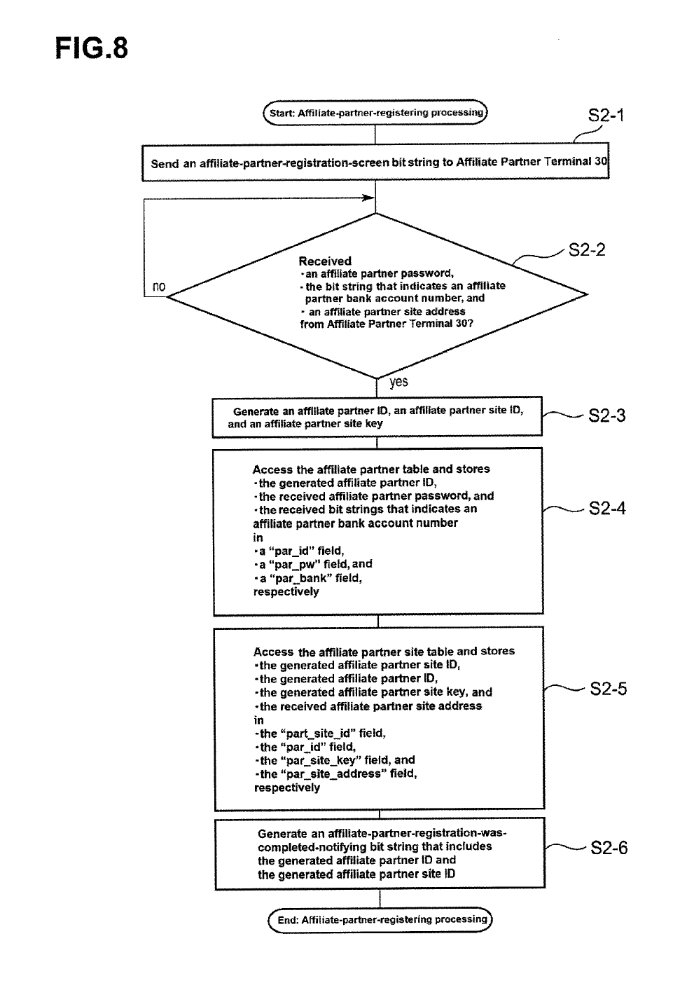

Next, the operation of Affiliate Server 10 according to the embodiment is described with reference to from FIG. 8 to FIG. 21. As described above, in Affiliate Server 10, the affiliate-partner-registering processing (step S2), the advertising-client-registering processing (step S5), the affiliate-partner-login processing (step S8), the advertisement-tag-list-disclosing processing (step S11), the redirect processing (step S17), the reward-payment-approving processing (step S23), the checking processing (step S26), the advertising-client-login processing (step S29), the market-data-disclosing processing (step S32), and the network-composition-modifying processing (step S35) are executed. These processing are explained below in order.

### (Affiliate-Partner-Registering Processing: Step S2)

First, the affiliate-partner-registering processing is explained with reference to FIG. 8. FIG. 8 is a flowchart illustrating the affiliate-partner-registering processing. Affiliate Server 10, if received an affiliate-partner-registration-requesting bit string (see step S1) from Affiliate Partner Terminal 30, starts the following affiliate-partner-registering processing.

### <Step S2-1>

First, Affiliate Server 10 sends an affiliate-partner-registration-screen bit string to Affiliate Partner Terminal 30 (step S2-1). Where, the affiliate-partner-registration-screen bit string is a bit string that constructs an affiliate partner registration screen and the affiliate partner registration screen is the web page to be an interface when inputting affiliate-partner-registration-data bit string.

Note that the affiliate-partner-registration-data bit string is a bit string to be stored in Affiliate Server 10 as the information regarding affiliate partner. The following explanation uses an affiliate partner password, a bit string that indicates affiliate partner's bank account number, and an affiliate partner site address as an affiliate-partner-registration-data bit string, while the present invention can uses the bit strings other than those bit strings as an affiliate-partner-registration-bit strings.

### <Step S2-2>

Next, Affiliate Server 10 stands by until receiving an affiliate partner password, the bit string that indicates affiliate partner's bank account number, and affiliate partner site address from Affiliate Partner Terminal 30 (step S2-2).

### <Step S2-3>

Affiliate Server 10, if received an affiliate partner password, the bit string that indicates affiliate partner's bank account number, and an affiliate partner site address from Affiliate Partner Terminal 30, generates an affiliate partner ID, an affiliate partner site ID, and an affiliate partner site key (step S2-3).

### <Step S2-4>

Next, Affiliate Server 10 accesses the affiliate partner table (see FIG. 4 (a)) and stores the generated affiliate partner ID, the received affiliate partner password, and the received bit string that indicates the affiliate partner bank account number in the “par_id” field, the “par_pw” field, and the “par_bank” field, respectively (step S2-4).

### <Step S2-5>

Next, Affiliate Server 10 accesses the affiliate partner site table (see FIG. 4 (b)), stores the generated affiliate partner site ID, the generated affiliate partner ID, the generated affiliate partner site key, and the received affiliate partner site address in the “par_site_id” field, the “par_id” field, the “par_site_key” field, and the “par_site_address” field, respectively (step S2-5).

### <Step S2-6>

And, Affiliate Server 10 generates an affiliate-partner-registration-was-completed-notifying bit string that includes the generated affiliate partner ID and the generated affiliate partner site ID (step S2-6) and finishes the affiliate-partner-registering processing.

### (Advertising-Client-Registering Processing: Step S5)

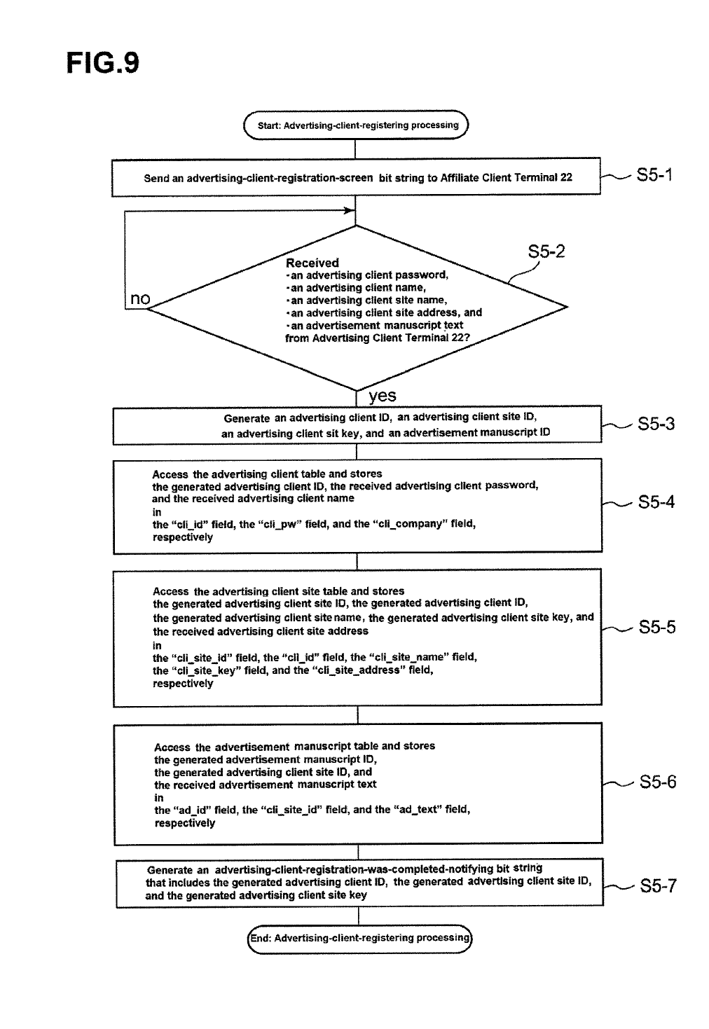

Next, the advertising-client-registering processing is described with reference to FIG. 9. FIG. 9 is a flowchart illustrating the advertising-client-registering processing. Affiliate Server 10, if received an advertising-client-registration-requesting bit string from Advertising Client Terminal 22 (see step S4), starts the following advertising-client-registering processing.

### <Step S5-1>

First, Affiliate Server 10 sends an advertising-client-registration-screen bit string to Advertising Client Terminal 22 (step S5-1). The advertising-client-registration-screen bit string is a bit string that constructs an advertising-client-registration-screen and the advertising-client-registration-screen is the web page to be an interface when inputting advertising-client-registration-data bit strings.

Note that the advertising-client-registration-data bit string is a bit string to be stored in Affiliate Server 10 as the information regarding advertising client. The below explanation uses an advertising client password, an advertising client name, an advertising client site name, an advertising client site address, and an advertisement manuscript text as advertising-client-registration-data bit strings, while the present invention can use the bit strings other than those bit strings as advertising-client-registration-data bit strings.

### <Step S5-2>

Next, Affiliate Server 10 stands by until receiving an advertising client password, an advertising client name, an advertising client site name, an advertising client site address, and an advertising client manuscript text from Advertising Client Terminal 22 (step S5-2).

### <Step S5-3>

Affiliate Server 10, if received an advertising client password, an advertising client name, an advertising client site name, an advertising client site address, and an advertisement manuscript text from Advertising Client Terminal 22, generates an advertising client ID, an advertising client site ID, an advertising client sit key, and advertisement manuscript ID (step S5-3).

### <Step S5-4>

Next, Affiliate Server 10 accesses the advertising client table (see FIG. 5 (a)) and stores the generated advertising client ID, the received advertising client password, and the received advertising client name in the “cli_id” field, the “cli_pw” field, and the “cli_company” field, respectively (step S5-4).

### <Step S5-5>

Next, Affiliate Server 10 accesses the advertising client site table (FIG. 5 (b)) and stores the generated advertising client site ID, the generated advertising client ID, the received advertising client site name, the generated advertising client site key, and the received advertising client site address in the “cli_site_id” field, the “chid” field, the “cli_site_name” field, the “cli_site_key” field, and the “cli_site_address” field, respectively (step S5-5).

### <Step S5-6>

Next, Affiliate Server 10 accesses the advertisement manuscript table (see FIG. 5 (c)) and stores the generated advertisement manuscript ID, the generated advertising client site ID, and the received advertisement manuscript text in the “ad_id” field, the “cli_site_id” field, and the “ad_text” field, respectively (step S5-6).

### <Step S5-7>

And, Affiliate Server 10 generates an advertising-client-registration-was-completed-notifying bit string that includes the generated advertising client ID, the generated advertising client site ID, and the generated advertising client site key (step S5-7) and finishes the advertising-client-registering processing.

### (Affiliate-Partner-Login Processing: Step S8)

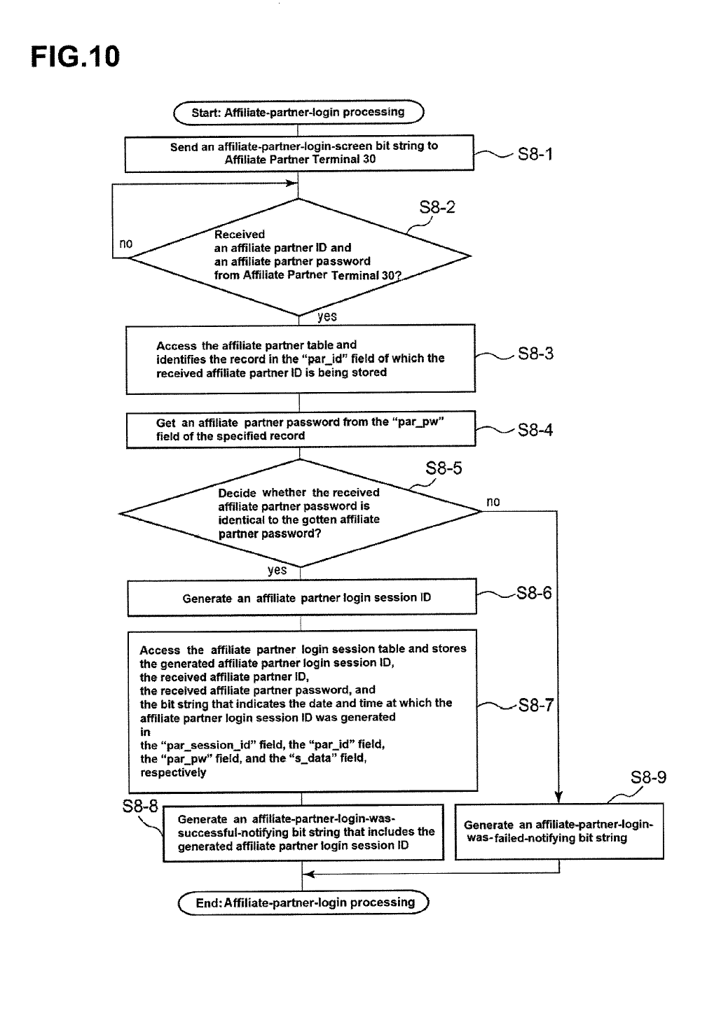

Next, the affiliate-partner-login processing is explained with reference to FIG. 10. FIG. 10 is a flowchart illustrating the affiliate-partner-login processing. Affiliate Server 10, if received an affiliate-partner-login-requesting bit string from Affiliate Partner Terminal 30 (see step S7), starts the following affiliate-partner-login processing.

### <Step S8-1>

Next, Affiliate Server 10 sends an affiliate-partner-login-screen bit string to Affiliate Terminal 30 (step S8-1). The affiliate-partner-login-screen bit string is a bit string that constructs an affiliate partner login screen and the affiliate partner login screen is the web page to be an interface when inputting affiliate-partner-login-data bit strings.

Note that affiliate-partner-login-data bit strings are bit strings to be needed when logging into Affiliate Server 10 from Affiliate Partner Terminal 30. The below explanation uses an affiliate partner ID and an affiliate partner password as affiliate-partner-login-data bit strings, while the present invention can use the bit strings other than those bit strings as affiliate-partner-login-data bit strings.

### <Step S8-2>

Next, Affiliate Server 10 stands by until received an affiliate partner ID and an affiliate partner password from Affiliate Partner Terminal 30 (step S8-2).

### <Step S8-3>

Affiliate Server 10, if received an affiliate partner ID and an affiliate partner password from Affiliate Partner Terminal 30, accesses the affiliate partner table (see FIG. 4 (a)), identifies the record in the “par_id” field of which the received affiliate partner ID is being stored (step S8-3).

### <Step S8-4>

Next, Affiliate Server 10 gets an affiliate partner password from the “par_pw” field of the specified record (step S8-4).

### <Step S8-5>

Next, Affiliate Server 10 decides whether the received affiliate partner password is identical to the gotten affiliate partner password (step S8-5), and proceeds to step S8-6 if it is identical but proceeds to step S8-9 if it is not identical.

### <Step S8-6>

Affiliate Server 10, if the received affiliate partner password is identical to the gotten affiliate partner password, generates an affiliate partner login session ID (step S8-6).

### <Step S8-7>

Next, Affiliate Server 10 accesses the affiliate partner login session table (see FIG. 6 (b)) and stores the generated affiliate partner login session ID, the received affiliate partner ID, the received affiliate partner password, and the bit string that indicates the date and time at which the affiliate partner login session ID was generated in the “par_session_id” field, the “par_id” field, the “par_pw” field, and the “s_date” field, respectively (step S8-7).

### <Step S8-8>

And, Affiliate Server 10 generates an affiliate-partner-login-was-successful-notifying bit string that includes the generated affiliate partner login session ID (step S8-8) and finishes the affiliate-partner-login processing.

### <Step S8-9>

Affiliate Server 10, if the received affiliate partner password and the gotten affiliate partner password are not identical at step S8-5, generates an affiliate-partner-login-was-failed-notifying bit string that notifies the failure of affiliate partner login (step S8-9) and finishes the affiliate-partner-login processing.

### (Advertisement-Tag-List-Disclosing Processing: Step S11)

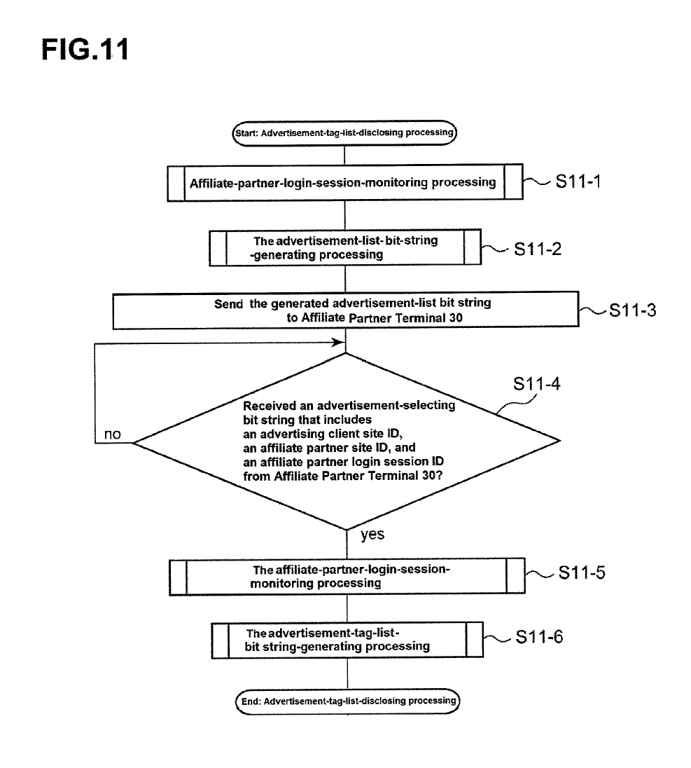

Next, the advertisement-tag-list-disclosing processing is explained with reference to FIG. 11. FIG. 11 is a flowchart illustrating the advertisement-tag-list-disclosing processing. Affiliate Server 10, if received an advertisement-tag-list-disclosure-requesting bit string from Affiliate Partner Terminal 30 (see step S10), starts the following advertisement-tag-list-disclosing processing. Note that, as described above, the advertisement-tag-list-disclosure-requesting bit string includes an affiliate partner site ID and an affiliate partner login session ID.

### <Step S11-1>

First, Affiliate Server 10 executes the affiliate-partner-login-session-monitoring processing (step S11-1).

### <Step S11-2>

Next, Affiliate Server 10 executes the advertisement-list-bit-string-generating processing (step S11-2).

### <Step S11-3>

Next, Affiliate Server 10 sends the generated advertisement-list bit string to Affiliate Partner Terminal 30 (step S11-3).

### <Step S11-4>

Next, Affiliate Server 10 stands by until receiving an advertisement-selecting bit string that includes an advertising client site ID, an affiliate partner site ID, and an affiliate partner login session ID from Affiliate Partner Terminal 30 (step S11-4).

### <Step S11-5>

Affiliate Server 10, if received an advertisement-selecting bit string from Affiliate Partner Terminal 30, executes the affiliate-partner-login-session-monitoring processing (step S11-5).

### <Step S11-6>

Next, Affiliate Server 10 executes the advertisement-tag-list-bit-string-generating processing (step S11-6) and finishes the advertisement-tag-list-disclosing processing.

### (Affiliate-Partner-Login-Session-Monitoring Processing: Step S11-1, S11-5)

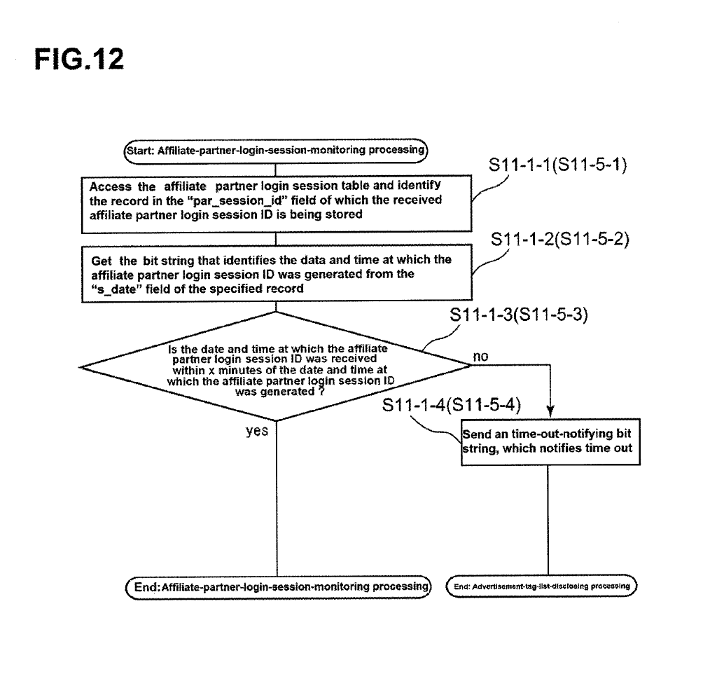

Next, the affiliate-partner-login-session-monitoring processing is described with reference to FIG. 12. FIG. 12 is a flowchart illustrating the affiliate-partner-login-session-monitoring processing.

### <Step S11-1-1, S11-5-1>

First, Affiliate Server 10 accesses the affiliate partner login session table (see FIG. 6 (b)) and identifies the record in the “par_session_id” field of which the received affiliate partner login session ID is being stored (step S11-1-1, S11-5-1).

### <Step S11-1-2, S11-5-2>

Next, Affiliate Server 10 gets the bit string that indicates the date and time at which the affiliate partner login session ID was generated from the “s_date” field of the specified record (step S11-1-2, S11-5-2).

### <Step S11-1-3, S11-5-3>

Next, Affiliate Server 10 decides whether the date and time at which the affiliate partner login session ID was received is within x minutes of the date and time at which the affiliate partner login session ID was generated, based on the bit string that indicates the date and time at which the affiliate partner login session ID was received and the bit string that indicates the date and time at which the affiliate partner login session ID was generated (step S11-1-3, S11-5-3). And, Affiliate Server 10 finishes the affiliate-partner-login-session-monitoring processing if it is within the x minutes, while proceeds to step S11-1-4 (S11-5-4) if it is not within the x minutes.

### <Step S11-1-4, S11-5-4>

Affiliate Server 10, if it is not within the x minutes, sends an time-out-notifying bit string, which notifies time out, to Affiliate Partner Terminal 30 (step S11-1-4, S11-5-4, the illustrating in FIG. 2 is omitted) and finishes the advertisement-tag-list-disclosing processing.

### (Advertisement-List-Bit-String-Generating Processing: Step S11-2)

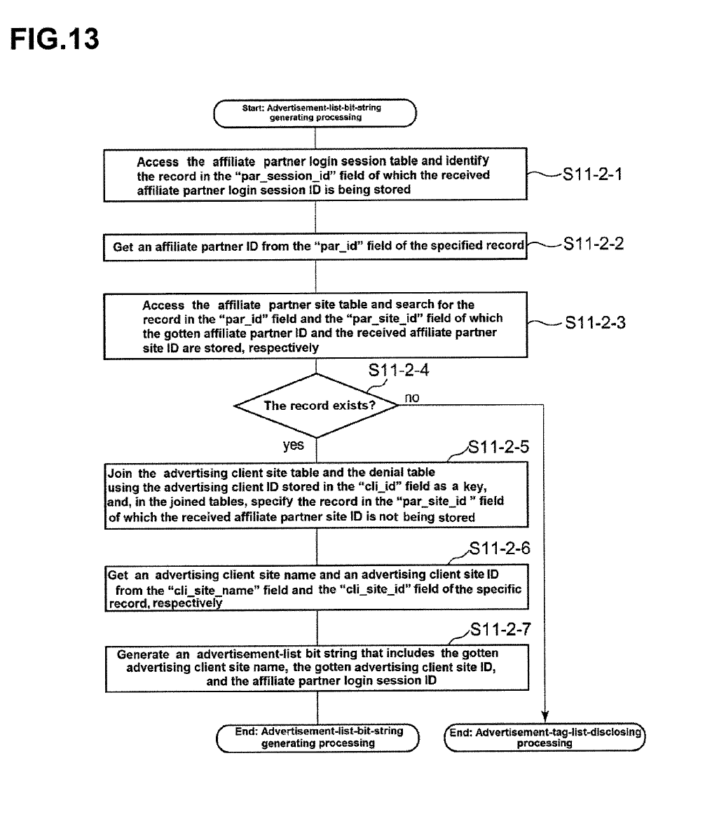

Next, the advertisement-list-bit-string-generating processing is described with reference to FIG. 13. FIG. 13 is a flowchart illustrating the advertisement-list-bit-string-generating processing.

### <Step S11-2-1>

First, Affiliate Server 10 accesses the affiliate partner login session table (see FIG. 6 (b)) and identifies the record in the “par_session_id” field of which the received affiliate partner login session ID is being stored (step S11-2-1).

### <Step S11-2-2>

Next, Affiliate Server 10 gets an affiliate partner ID from the “par_id” field of the specified record (step S11-2-2).

### <Step S11-2-3>

Next, Affiliate Server 10 accesses the affiliate partner site table (see FIG. 4 (b)) and searches for the record in the “par_id” field and the “par_site_id” field of which the gotten affiliate partner ID and the received affiliate partner site ID are stored, respectively (step S11-2-3).

### <Step S11-2-4>

Next, Affiliate Server 10 decides whether the record exists (step S11-2-4), if it exists, proceeds to the next step S11-2-5, while finishes the advertisement-tag-list-disclosing processing if it does not exist.

### <Step S11-2-5>

Next, Affiliate Server 10 joins the advertising client site table (see FIG. 5 (b)) and the denial table (see FIG. 7 (b)) using the advertising client ID stored in the “cli_id” field as a key, and, in the joined tables, specifies the record in the “par_site_id” field of which the received affiliate partner site ID is not being stored (step S11-2-5).

### <Step S11-2-6>

Next, Affiliate Server 10 gets an advertising client name and an advertising client site ID from the “cli_site_name” field and the “cli_site_id” field of the specific record, respectively (step S11-2-6).

### <Step S11-2-7>

And, Affiliate Server 10 generates an advertisement-list bit string that includes the gotten advertising client site name, the gotten advertising client site ID, and the affiliate partner login session ID (step S11-2-7) and finishes the advertisement-list-bit-string-generating processing.

### (Advertisement-Tag-List Bit String-Generating Processing: Step S11-6)

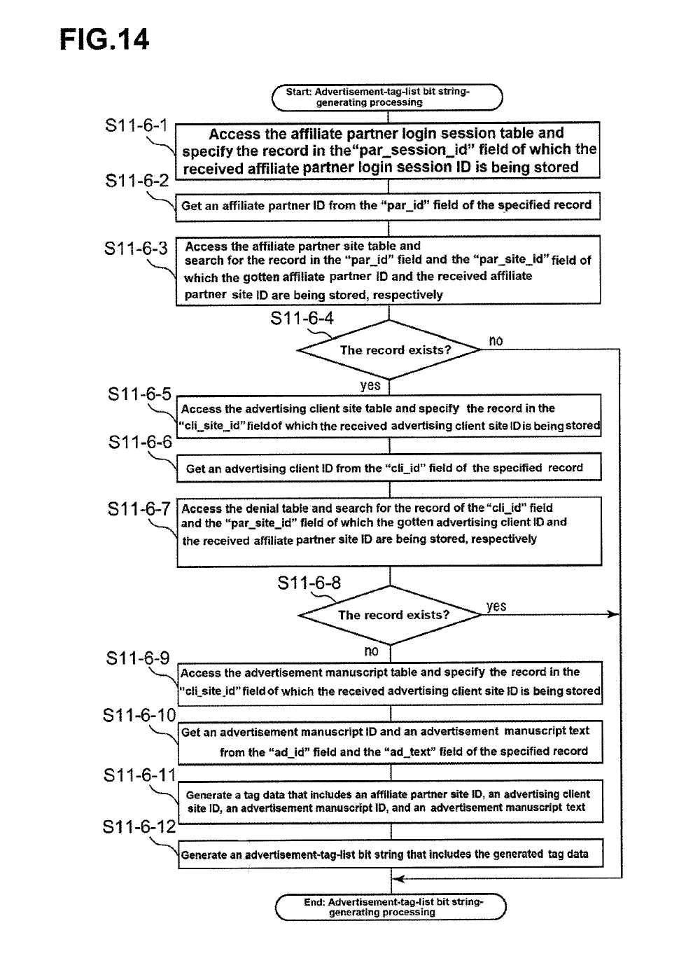

Next, the advertisement-tag-list-bit-string-generating processing is described with reference to FIG. 14. FIG. 14 is a flowchart illustrating the advertisement-tag-list-bit-string-generating processing.

### <Step S11-6-1>

First, Affiliate Server 10 accesses the affiliate partner login session table (see FIG. 6 (b)) and specifies the record in the “par_session_id” field of which the received affiliate partner login session ID is being stored (step S11-6-1).

### <Step S11-6-2>

Next, Affiliate Server 10 gets an affiliate partner ID from the “par_id” field of the specified record (step S11-6-2).

### <Step S11-6-3>

Next, Affiliate Server 10 accesses the affiliate partner site table (see FIG. 4 (b)) and searches for the record in the “par_id” field and the “par_site_id” field of which the gotten affiliate partner ID and the received affiliate partner site ID are being stored, respectively (step S11-6-3).

### <Step S11-6-4>

Next, Affiliate Server 10 decides whether the record exists (step S11-6-4), if it exists, proceeds to step S11-6-5, while finishes the advertisement-tag-list-bit-string-generating processing.

### <Step S11-6-5>

Next, Affiliate Server 10 accesses the advertising client site table (see FIG. 5 (b)) and specifies the record in the “cli_siteid” field of which the received advertising client site ID is being stored (step S11-6-5).

### <Step S11-6-6>

Next, Affiliate Server 10 gets an advertising client ID from the “cli_id” field of the specified record (step S11-6-6).

### <Step S11-6-7>

Next, Affiliate Server 10 accesses the denial table (see FIG. 7 (b)) and searches for the record of the “cli_id” field and the “par_site_id” field of which the gotten advertising client ID and the received affiliate partner site ID are being stored, respectively (step S11-6-7).

### <Step S11-6-8>

Next, Affiliate Server 10 decides whether the record exists (step S11-6-8) and proceeds to step S11-6-9 if it does not exist, while finishes the advertisement-tag-list-bit-string-generating processing if it exist.

### <Step S11-6-9>

Next, Affiliate Server 10 accesses the advertisement manuscript table (see FIG. 5 (c)) and specifies the record in the “cli_site_id” field of which the received advertising client site ID is being stored (step S11-6-9).

### <Step S11-6-10>

Next, Affiliate Server 10 gets an advertisement manuscript ID and an advertisement manuscript text from the “ad_id” field and the “ad_text” field of the specified record (step S11-6-10).

### <Step S11-6-11>

Next, Affiliate Server 10 generates a tag data that includes an affiliate partner site ID, an advertising client site ID, an advertisement manuscript ID, and an advertisement manuscript text (step S11-6-11).

### <Step S11-6-12>

Then, Affiliate Server 10 generates an advertisement-tag-list bit string that includes the generated tag data (step S11-6-12) and finishes the advertisement-tag-list-bit-string-generating processing.

### (Redirect Processing: Step S17)

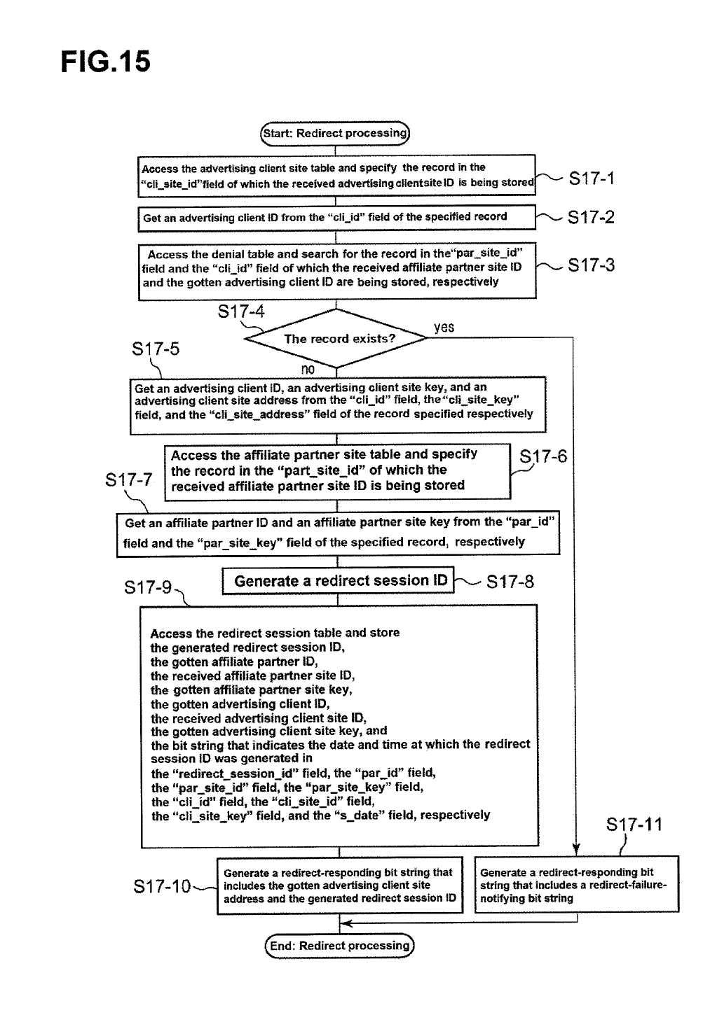

Next, the redirect processing is described with reference to FIG. 15. FIG. 15 is a flowchart illustrating the redirect processing. Affiliate Server 10, if received a redirect-requesting bit string from Viewer Terminal 50 (see step S16), starts the following redirect processing. Note that, as described above, the redirect-requesting bit string includes an affiliate partner site ID, an advertising client site ID, and an advertisement manuscript ID.

### <Step S17-1>

First, Affiliate Server 10 accesses the advertising client site table (see FIG. 5 (b)) and specifies the record in the “cli_site_id” field of which the received advertising client site ID is being stored (step S17-1).

### <Step S17-2>

Next, Affiliate Server 10 gets an advertising client ID from the “cli_id” field of the specified record (step S17-2).

### <Step S17-3>

Next, Affiliate Server 10 accesses the denial table (see FIG. 7 (b)) and searches for the record in the “par_site_id” field and the “chid” field of which the received affiliate partner site ID and the gotten advertising client ID are being stored, respectively (step S17-3).

### <Step S17-4>

Next, Affiliate Server 10 decides whether the record exists (step S17-4), if it does not exist, proceeds to step S17-5, while proceeds to step S17-11 if it exists.

### <Step S17-5>

Next, Affiliate Server 10 gets an advertising client ID, an advertising client site key, and an advertising client site address from the “cli_id” field, the “cli_site_key” field, and the “cli_site_address” field of the record specified at step S17-1, respectively (step S17-5).

### <Step S17-6>

Next, Affiliate Server 10 accesses the affiliate partner site table (see FIG. 4 (b)) and specifies the record in the “par_site_id” of which the received affiliate partner site ID is being stored (step S17-6).

### <Step S17-7>

Next, Affiliate Server 10 gets an affiliate partner ID and an affiliate partner site key from the “par_id” field and the “par_site_key” field of the specified record, respectively (step S17-7).

### <Step S17-8>

Next, Affiliate Server 10 generates a redirect session ID (step S17-8).

### <Step S17-9>

Next, Affiliate Server 10 accesses the redirect session table (see FIG. 6 (a)) and stores the generated redirect session ID, the gotten affiliate partner ID, the received affiliate partner site ID, the received affiliate partner site key, the gotten advertising client ID, the received advertising client site ID, the gotten advertising client site key, and the bit string that indicates the date and time at which the redirect session ID was generated in the “redirect_session_id” field, the “par_id” field, the “par_site_id” field, the “par_site_key” field, the “dud” field, the “cli_site_id” field, the “cli_site_key” field, and the “s_date” field, respectively (step S17-9).

### <Step S17-10>

And, Affiliate Server 10 generates a redirect-responding bit string that includes the gotten advertising client site address and the generated redirect session ID (step S17-10) and finishes the redirect processing.

### <Step S17-11>

Affiliate Server 10, if the record exists at step S17-4, generates a redirect-responding bit string that includes a redirect-failure-notifying bit string and finishes the redirect processing. Note that the redirect-failure-notifying bit string is a bit string notifying the failure of the redirect processing.

### (Reward-Payment-Approving Processing: Step S23)

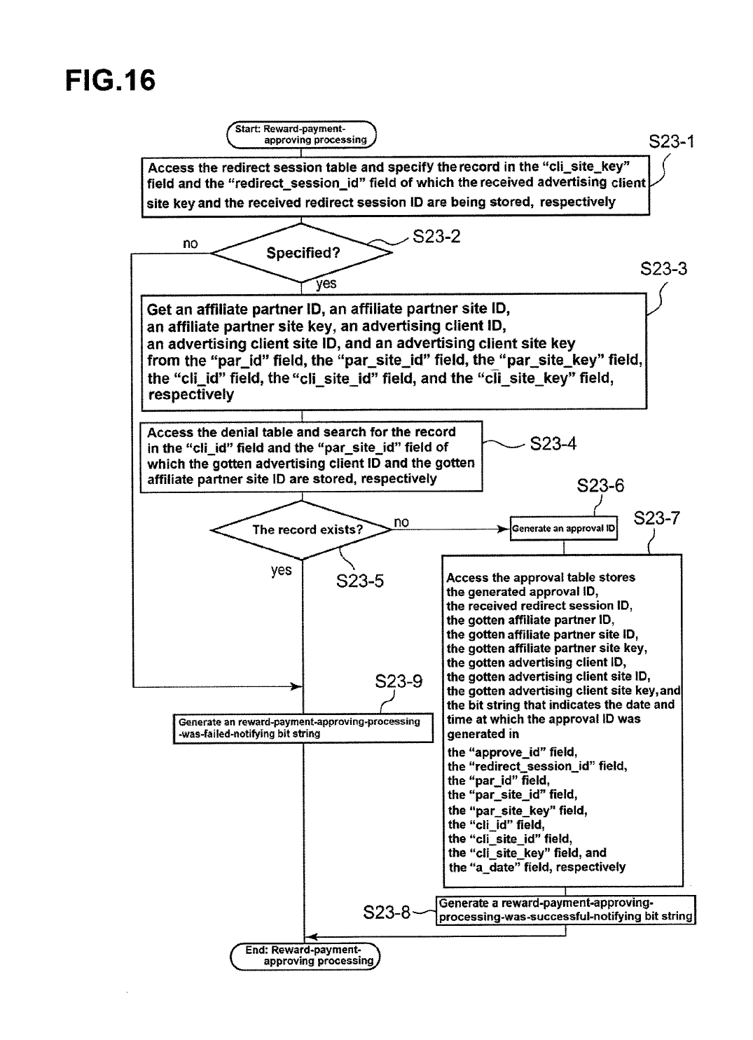

Next, the reward-payment-approving processing is described with reference to FIG. 16. FIG. 16 is a flowchart illustrating the reward-payment-approving processing. Affiliate Server 10, if received a reward-payment-approval-notifying bit string from Advertising Client Server 21 (see step S22), starts the following reward-payment-approving processing. Note that, as described above, the reward-payment-approval-notifying bit string includes a redirect session ID and an advertising client site key.

### <Step S23-1>

First, Affiliate Server 10 accesses the redirect session table (see FIG. 6 (a)) and specifies the record in the “cli_site_key” field and the “redirect_session_id” field of which the received advertising client site key and the received redirect session ID are being stored, respectively (step S23-1).

### <Step S23-2>

Next, Affiliate Server 10 decides whether it was specified (step S23-2), if it was specified, proceeds to step S23-3, while proceeds to step S23-9 if it was not specified.

### <Step S23-3>

Next, Affiliate Server 10 gets an affiliate partner ID, an affiliate partner site ID, an affiliate partner site key, an advertising client ID, an advertising client site ID, and an advertising client site key from the “par_id” field, the “par_site_id” field, the “par_site_key” field, the “chid” field, the “cli_site_id” field, and the “cli_site_key” field, respectively (step S23-3).

### <Step S23-4>

Next, Affiliate Server 10 accesses the denial table (see FIG. 7 (b)) and searches for the record in the “cli_id” field and the “par_site_id” field of which the gotten advertising client ID and the gotten affiliate partner site ID are stored, respectively (step S23-4).

### <Step S23-5>

Next, Affiliate Server 10 decides whether the record exists (step S23-5), if it exists, proceeds to step S23-9, while proceeds to step S23-6 if it does not exist.

### <Step S23-6>

Next, Affiliate Server 10 generates an approval ID (step S23-6).

### <Step S23-7>

Next, Affiliate Server 10 accesses the approval table (see FIG. 7 (a)) and stores the generated approval ID, the received redirect session ID, the gotten affiliate partner ID, the gotten affiliate partner site ID, the gotten affiliate partner site key, the gotten advertising client ID, the gotten advertising client site ID, the gotten advertising client site key, and the bit string that indicates the date and time at which the approval ID was generated in the “approve_id” field, the “redirect_session_id” field, the “par_id” field, the “par_site_id” field, “par_site_key” field, “cli_id” field, “cli_site_id” field, “cli_site_key” field, and “a_date” field, respectively (step S23-7).

### <Step S23-8>

Next, Affiliate Server 10 generates a reward-payment-approving-processing-was-successful-notifying bit string (step S23-8) and finishes the reward-payment-approving processing.

### <Step S23-9>

Affiliate Server 10, if it could not specify at step S23-2 or the record existed at step S23-5, generates an reward-payment-approving-processing-was-failed-notifying bit string (step S23-9) and finishes the reward-payment-approving processing.

### (Checking Processing: Step S26)

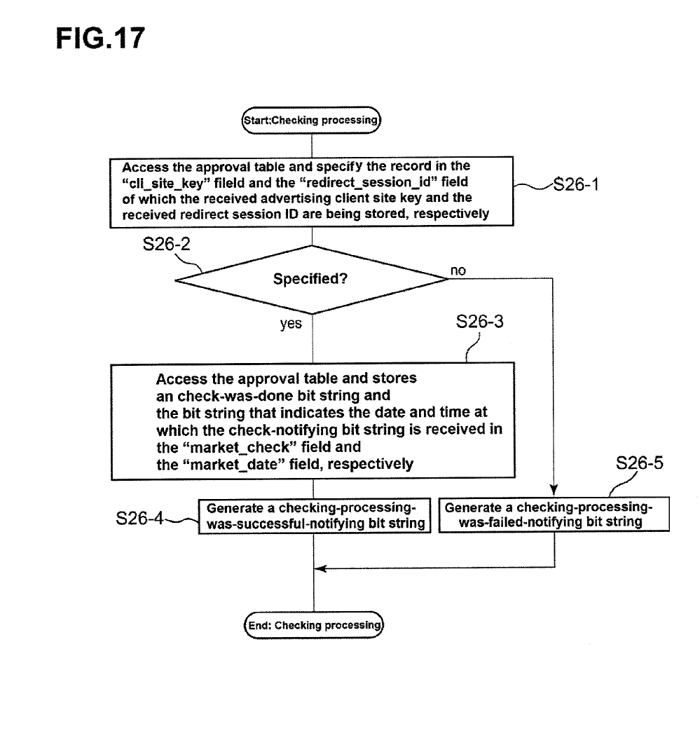

Next, the checking processing is described with reference to FIG. 17. FIG. 17 is a flowchart illustrating the checking processing. Affiliate Server 10, if received a check-notifying bit string from Advertising Client Server 21 (see step S25), starts the following checking processing. Note that, as described above, the check-notifying bit string includes a redirect session ID and an advertising client site key.

### <Step S26-1>

First, Affiliate Server 10 accesses the approval table (see FIG. 7 (a)) and specifies the record in the “cli_site_key” field and the “redirect_session_id” field of which the received advertising client site key and the received redirect session ID are being stored, respectively (step S26-1).

### <Step S26-2>

Next, Affiliate Server 10 decides whether it could specify (step S26-2) and proceeds to step S26-3 if it could specify, while proceeds to step S26-5 if it could not specify.

### <Step S26-3>

Next, Affiliate Server 10 accesses the approval table (see FIG. 7 (a)) and stores an check-was-done bit string and the bit string that indicates the date and time at which a check-notifying bit string is received in the “market_check” field and the “market_date” field, respectively (step S26-3).

### <Step S26-4>

And, Affiliate Server 10 generates a checking-processing-was-successful-notifying bit string that notifies the success of the checking processing (step S26-4) and finishes the checking processing.

### <Step S26-5>

Affiliate Server 10, if it could not specify at step S26-2, generates a checking-processing-was-failed-notifying bit string that notifies the failure of the checking processing and finishes checking processing.

### (Advertising-Client-Login Processing: Step S29)

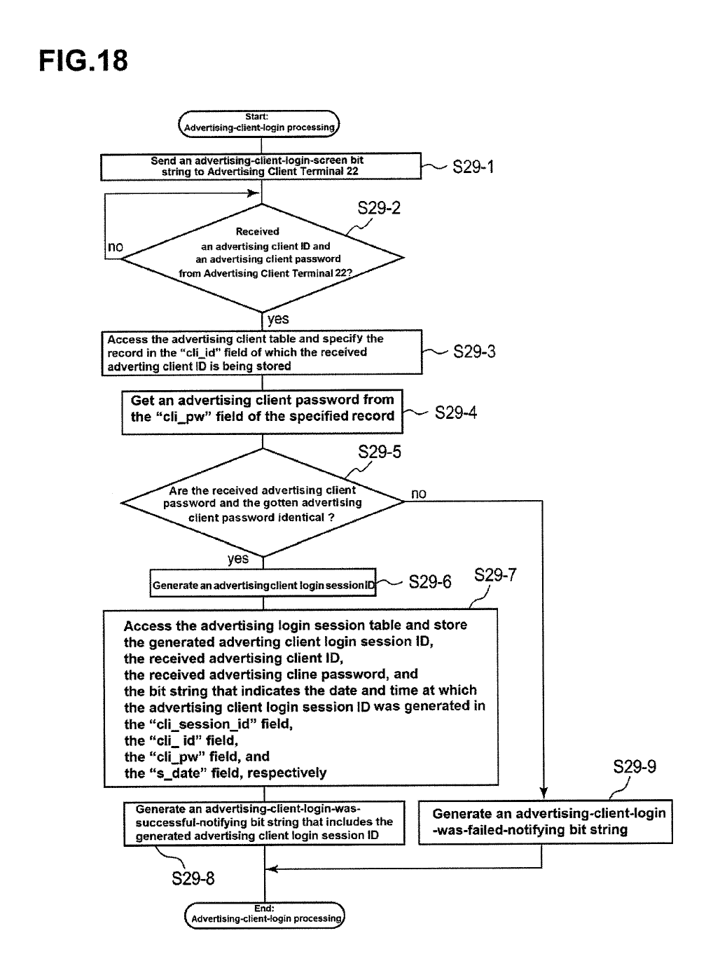

Next, the advertising-client-login processing is described with reference to FIG. 18. FIG. 18 is a flowchart illustrating the advertising-client-login processing. Affiliate Server 10, if received an advertising-client-login-requesting bit string from Advertising Client Terminal 22 (see step S28), starts the following advertising-client-login processing.

### <Step S29-1>

First, Affiliate Server 10 sends an advertising-client-login-screen bit string to Advertising Client Terminal 22 (step S29-1). The advertising-client-login-screen bit string is a bit string that constructs an advertising client login screen and the advertising login screen is the web page to be an interface when inputting advertising-client-login-data bit strings.

Note that advertising-client-login-data bit strings are bit strings to be needed when logging into Affiliate Server 10 from Advertising Client Terminal 22. The following description uses an advertising client ID and an advertising client password as advertising-client-login-data bit strings, while the present invention can use the bit strings other than those bit strings as advertising-client-login-data bit strings.

### <Step S29-2>

Next, Affiliate Server 10 stands by until receiving an advertising client ID and an advertising client password from Advertising Client Terminal 22 (step S29-2).

### <Step S29-3>

Affiliate Server 10, if received an advertising client ID and an advertising client password from Advertising Client Terminal 22, accesses the advertising client table (see FIG. 5 (a)) and specifies the record in the “cli_id” field of which the received advertising client ID is being stored (step S29-3).

### <Step S29-4>

Next, Affiliate Server 10 gets an advertising client password from the “cli_pw” field of the specified record (step S29-4).

### <Step S29-5>

Next, Affiliate Server 10 decides whether the received advertising client password and the gotten advertising client password are identical to each other (step S29-5) and proceeds to step S29-6 if identical, while proceed to step S 29-9 if not identical.

### <Step S29-6>

Next, Affiliate Server 10 generates an advertising client login session ID (step S29-6).

### <Step S29-7>

Next, Affiliate Server 10 accesses the advertising login session table (see FIG. 6 (c)) and stores the generated advertising client login session ID, the received advertising client ID, the received advertising client password, and the bit string that indicates the date and time at which the advertising client login session ID was generated in the “cli_session_id” field, the “cli_id” field, the “cli_pw” field, and the “s_date” field, respectively (step S29-7).

### <Step S29-8>

Then, Affiliate Server 10 generates an advertising-client-login-was-successful-notifying bit string that includes the generated advertising client login session ID and finishes the advertising-client-login processing.

### <Step S29-9>

Affiliate Server 10, if the received advertising client password and the gotten advertising client password were not identical to each other at step S29-5, generates an advertising-client-login-was-failed-notifying bit string (step S29-9) and finishes the advertising-client-login processing.

### (Market-Data-Disclosing Processing: Step S32)

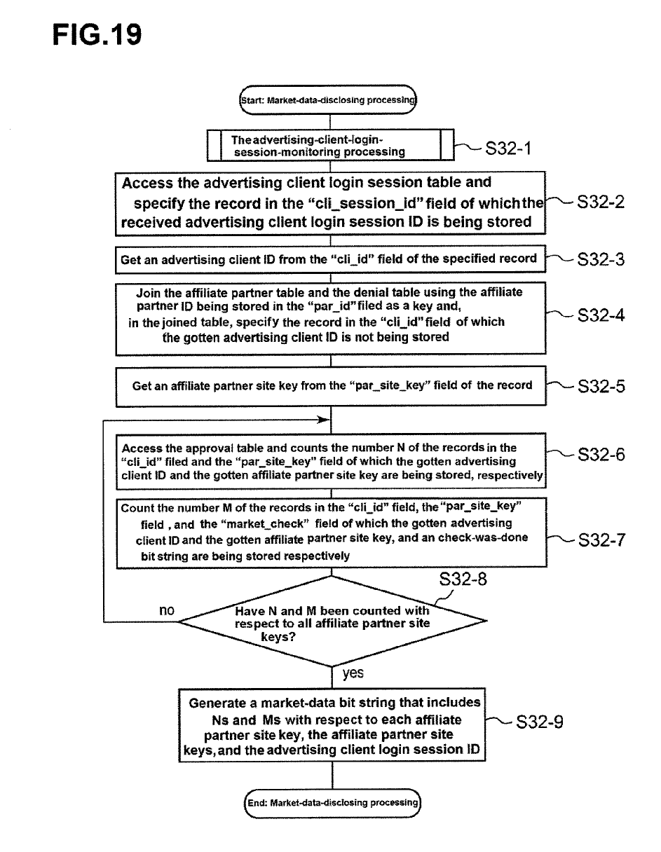

Next, the market-data-disclosing processing is described with reference to FIG. 19. FIG. 19 is a flowchart illustrating the market-data-disclosing processing. Affiliate Server 10, if received a market-data-disclosure-requesting bit string from Advertising Client Terminal 22 (see step S31), starts the following market-data-disclosing processing. Note that, as described above, a market-data-disclosure-requesting bit string includes an advertising client login session ID.

### <Step S32-1>

First, Affiliate Server 10 executes the advertising-client-login-session-monitoring processing (step S32-1).

### <Step S32-2>

Next, Affiliate Server 10 accesses the advertising client login session table (see FIG. 6 (c)) and specifies the record in the “cli_session_id” field of which the received advertising client login session ID is being stored (step S32-2).

### <Step S32-3>

Next, Affiliate Server 10 gets an advertising client ID from the “cli_id” field of the specified record (step S32-3).

### <Step 32-4>

Next, Affiliate Server 10 joins the affiliate partner table (see FIG. 4 (a)) and the denial table (see FIG. 7 (b)) using the affiliate partner ID being stored in the “par_id” filed as a key and, in the joined table, specifies the record in the “cli_id” field of which the gotten advertising client ID is not being stored (step S32-4).

### <Step S32-5>

Next, Affiliate Server 10 gets an affiliate partner site key from the “par_site_key” field of the specified record (step S32-5).

### <Step S32-6>

Next, Affiliate Server 10 accesses the approval table (see FIG. 7 (a)) and counts the number N of the records in the “cli_id” filed and the “par_site_key” field of which the gotten advertising client ID and the gotten affiliate partner site key are being stored, respectively (step S32-6).

### <Step S32-7>

Next, Affiliate Server 10 counts the number M of the records in the “cli_id” field, the “par_site_key” field, the “market_check” field of which the gotten advertising client ID and the gotten affiliate partner site key, and an check-was-done bit string are being stored respectively (step S32-7).

### <Step S32-8>

Next, Affiliate Server 10 decides whether N and M have been counted with respect to all affiliate partner site keys (step S32-8) and proceeds to step S32-9 if counted, while returns to step S32-6 if not counted.

### <Step S32-9>

Next, Affiliate Server 10 generates a market-data bit string that includes Ns and Ms regarding each affiliate partner site key, the affiliate partner site keys, and the advertising client login session ID (step S32-9) and finishes market-data-disclosing processing.

### (Network-Composition-Modifying Processing: Step S35)

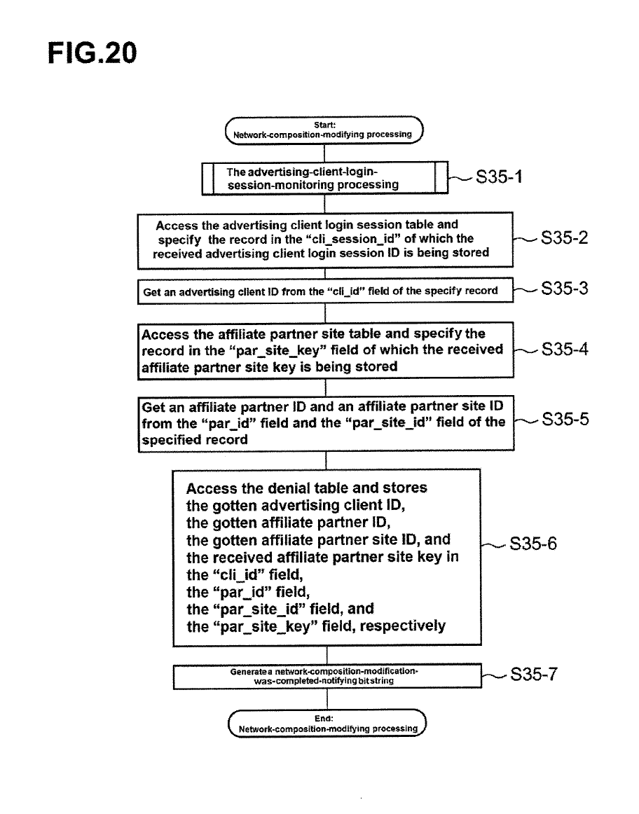

Next, the network-composition-modifying processing is described with reference to FIG. 20. FIG. 20 is a flowchart illustrating the network-composition-modifying processing. Affiliate Server 10, if received a network-composition-modification-notifying bit string from Advertising Client Terminal 22 (see step S34), starts the following network-composition-modifying processing. Note that, as described above, a network-composition-modification-notifying bit string includes an advertising client login session ID and an affiliate partner site key.

### <Step S35-1>

First, Affiliate Server 10 executes the advertising-client-login-session-monitoring processing (step S35-1).

### <Step S35-2>

Next, Affiliate Server 10 accesses the advertising client login session table (see FIG. 6 (c)) and specifies the record in the “cli_session_id” of which the received advertising client login session ID is being stored (step S35-2).

### <Step S35-3>

Next, Affiliate Server 10 gets an advertising client ID from the “cli_id” field of the specified record (step S35-3).

### <Step S35-4>

Next, Affiliate Server 10 accesses the affiliate partner site table (see FIG. 4 (b)) and specifies the record in the “par_site_key” field of which the received affiliate partner site key is being stored (step S35-4).

### <Step S35-5>

Next, Affiliate Server 10 gets an affiliate partner ID and an affiliate partner site ID from the “par_id” field and the “par_site_id” field of the specified record (step S35-5).

### <Step S35-6>

Next, Affiliate Server 10 accesses the denial table (see FIG. 7 (b)) and stores the gotten advertising client ID, the gotten affiliate partner ID, the gotten affiliate partner site ID, and the received affiliate partner site key in the “cli_id” field, the “par_id” field, the “par_site_id” field, and the “par_site_key” field, respectively (step S35-6).

### <Step S35-7>

Then, Affiliate Server 10 generates a network-composition-modification-completed-notifying bit string (step S35-7) and finishes the network-composition-modifying processing.

### (Advertising-Client-Login-Session-Monitoring Processing: Step S32-1, S35-1)

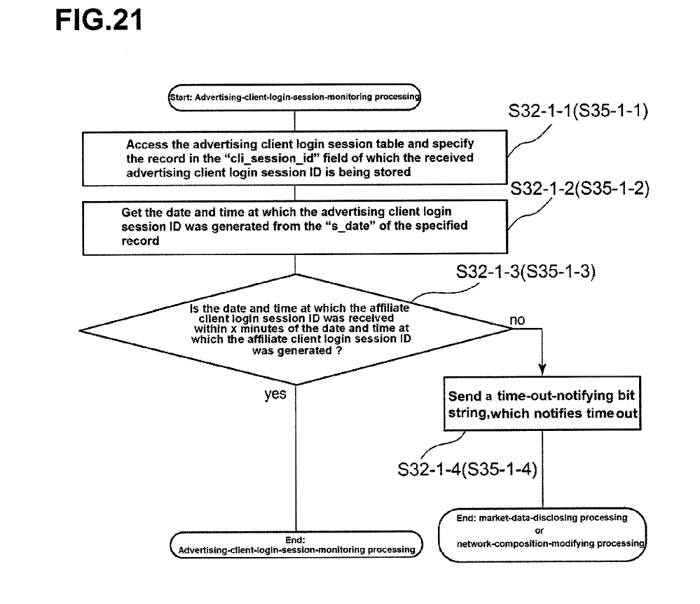

Next, the advertising-client-login-session-monitoring processing is described with reference to FIG. 21. FIG. 21 is a flowchart illustrating the advertising-client-login-session-monitoring processing.

### <Step S32-1-1, S35-1-1>

First, Affiliate Server 10 accesses the advertising client login session table (see FIG. 6 (c)) and specifies the record in the “cli_session_id” field of which the received advertising client login session ID is being stored (step S32-1-1, S35-1-1).

### <Step S32-1-2, S35-1-2>

Next, Affiliate Server 10 gets the date and time at which the advertising client login session ID was generated from the “s_date” of the specified record (step S32-1-2, S35-1-2).

### <Step S32-1-3, S35-1-3>

Next, Affiliate Server 10 decides whether the date and time at which the advertising client login session ID was received is within x minutes of the date and time at which the advertising client login session ID was generated, based on the bit string that indicates the date and time at which the advertising client login session ID was received and the bit string that indicates at which the advertising client login session ID was generated (step S32-1-3, S35-1-3). And, Affiliate Server 10, if it is within the x minutes, finishes the advertising-client-login-session-monitoring processing, while proceeds to step S32-1-4 (S35-1-4) if it is not within the x minutes.

### <Step S32-1-4, S35-1-4>

Affiliate Server 10, if it is not within the x minutes, sends time-out-notifying bit string, which notifies time out, to Advertising Client Terminal 22 (step S32-1-4, S35-1-4, the illustrating of this step in FIG. 2 is omitted) and finishes the market-data-disclosing processing or the network-composition-modifying processing.

As described above, according to the embodiment of the present invention, check-was-done bit strings are stored in Affiliate Server 10 with respect to each affiliate partner site and a market-data bit string generated by using the stored check-was-done bit strings is transmitted from Affiliate Server 10 to Advertising Client Terminal 22.

Thus, according to the embodiment of the present invention, using the bit string that indicates an event (cancel, repeat purchase, and so on) was occurred after approving a payment of a reward as a check-notifying bit string, it becomes possible at Advertising Client Terminal 22 to understand the customers' activities after purchasing the goods and services (cancel, repeat purchase, and so on).

Therefore, according to the embodiment of the present invention, an advertising client can decide whether the prospective customers viewing a certain affiliate partner site will be the customers the advertising client is seeking for and determines based on the result of the decision whether advertising client's network composition should include the affiliate partner site.

Consequently, according to the embodiment of the present invention, advertising client's customers are not formed on the initiative of its affiliate partners but on the initiative of the advertising client because the advertising client does not have to construct its network depending on affiliate partner sites' performances.

Furthermore, the embodiment of the present invention is preferable for forming customers on the initiative of advertising client because it is possible to exclude an affiliate partner site, even if the performances of the affiliate partner site is good, if it is decided that the prospect customers viewing the affiliate partner site will not be able to the customers the advertising client is seeking for.

In the present embodiment, the exclusion from a network composition is performed with respect to the advertisement-tag-list-disclosing processing, which is an example of an advertisement disclosing processing, the redirect processing, and the reward-payment-approving processing, which is an example of the processing for storing a reward-payment-was-approved-bit string. It is preferable to perform exclusions by using the denial table as the embodiment. In this way, exclusions or cancellations of exclusions become possible only by modifying the content of the denial table without operating any other table. Affiliate Server 10 works day and night because a large number of affiliate partner sites exist on network in affiliate system. Furthermore, both viewer terminals' computer users and advertising clients suffer losses if, for example, an error occurs in business processing. Therefore the above structure is an especially preferable embodiment for affiliate systems because it simplifies table operations and eliminates the errors of tables.

Furthermore, in the above embodiment, if an affiliate partner site was excluded from advertising client's network composition, afterward, for the affiliate partner site, the advertisement-tag-list-disclosing processing, the redirect processing, and the storing processing of the reward-payment-was-approved-bit string will be suspended with respect to all advertising client sites managed by the advertising client. Therefore, the present embodiment is preferable for the case: the prospect customers who view a certain affiliate partner site are considered undesirable for a certain advertising client site managed by an advertising client, and also assumed undesirable for the other advertising client sites managed by the advertising client. This is because it enables Advertising Client Terminal 22 to exclude a certain affiliate partner site from the network composition without one-by-one proceedings with respect to each advertising client sites.

On the other hand, for the case where the prospect customers who view a certain affiliate partner site are considered undesirable for a certain advertising client site managed by an advertising client, but not assumed undesirable for the other advertising client sites managed by the advertising client, it is preferable to add the “cli_site_id” field to the denial table (see FIG. 7 (b)) or replacing the “cli_id” field of the denial table (see FIG. 7 (b)) with the “cli_site_id” field, and apply to the “cli_site_id” field the processing that was applied to the “cli_id” field of the denial table (see FIG. 7 (b)) in the above described embodiment. In this way, even if a certain affiliate partner site was excluded from the network composition regarding a certain advertising client site of a certain advertising client, the affiliate partner site is not excluded the network composition of the other advertising client sites managed by the advertising client because the network composition is modified with respect to each advertising client site.

Note that for the market circumstance where it is difficult to decide whether the prospect customers who view a certain affiliate partner site and are considered undesirable for a certain advertising client site managed by an advertising client are undesirable for the other advertising client sites managed by the advertising client, it is preferable to enable to select either the exclusion with respect to a certain advertising site or the exclusion with respect to all advertising client sites, by including an in-a-lump-exclusion-notifying bit string or an selective-exclusion-notifying bit string in an network-composition-modification-notifying bit string. In this case, the “cli_site_id” field and the in-a-lump exclusion field are added to the denial table (see FIG. 7 (b)) to decide whether in-a-lump exclusion or selective exclusion. And, if the bit string that indicates the exclusion in a lump is being stored in the in-a-lump exclusion field of the denial table (see FIG. 7 (b)), as the described above, the processing that was applied to the “cli_id” field of the denial table (see FIG. 7 (b)) is applied to the “cli_id” field, on the other hand, if the bit string that indicates the selective exclusion is being stored in the in-a-lump exclusion field of the denial table (see FIG. 7 (b)), the processing that was applied to the “cli_id” field of the denial table (see FIG. 7 (b)) is applied to the “cli_site_id” field.

Both structures are included in the term “for a specific affiliate partner site, means for suspending or not performing at least one of an advertisement-disclosing processing, a redirect processing, and a storing processing of said reward-payment-was-approved bit string with respect to said advertising client device”.

Note that, in the present invention, Affiliate Server 10 receives reward-payment-approval-notifying bit strings from Advertising Client Server 21.

However, Affiliate Server 10 can also receive reward-payment-approval-notifying bit strings from Advertising Client Terminal 22, which is an advertising client device other than Advertising Client Server 21.

And, Affiliate Server 10, by receiving an electric file constructing a reward-payment-approval-notifying bit string from Advertising Client Terminal 22 and by reading the content of the electric file, can also receive a reward-payment-approval-notifying bit string.

Furthermore, in the present invention, affiliate partner site ID can be transmitted and disclosed to Advertising Client Terminal 22, while, in the present embodiment, it is preferable to use affiliate partner site key for security.

Furthermore, in the present invention, for example, it is possible to improve security regarding the access from Advertising Client Server 21 to Affiliate Server 10 by checking Advertising Client Server 21's IP addresses without using advertising client site keys, while, in the present embodiment, advertising client site keys are used for improving security regarding the access from Advertising Client Server 21 to Affiliate Server 10.

Furthermore, in the present invention, for example, the session of the redirect processing can be identified by: describing a tag, which makes the browser of Viewer Terminal 50 access Affiliate Server 10, in the web page displaying the purchase completion screen, and making Viewer Terminal 50 send a cookie, which includes a redirect session ID, to Affiliate Server 10 if it purchased goods or services in the advertising client site. In this case, a redirect-response-notifying bit string includes a cookie including a redirect session ID.

Note that, in the present embodiment, the reward-payment-approval-notifying bit string and the reward-payment-was-approved can be same or different. Furthermore, the check-notifying bit string and the check-was-done bit string can be same or different.

In the present embodiment, more than one check-was-done bit string are stored with respect to one affiliate partner site. In this case, M, which is a number indicating how many check-was-done bit strings are stored with respect to an affiliate partner site, indicates the number of how many times Affiliate Server 10 received a check-notifying bit string from Advertising Client Server 21 with respect to affiliate partner site. In the present invention, however, for example, one check-was-done bit string is stored with respect to one affiliate partner site. In this case, the check-was-done bit string with respect to a certain affiliate partner site indicates the number of how many times Affiliate Server 10 received a check-notifying bit string from Advertising Client Server 21 with respect to affiliate partner site by itself. In this case, Affiliate Server 10 stores the bit string calculated by adding “1” to the stored check-was-done bit string as the new check-was-done bit string, when received a check-notifying bit string from Advertising Client Server 21.

Both cases, that is, the case where more than one check-was-done bit string are stored with respect to one affiliate partner site and the number that indicates how many check-was-done bit strings are stored has a sense, and the case where one check-was-done bit string is stored with respect to one affiliate partner site and the check-was-done bit string has a sense by itself, are included in the term “storing a check-was-done bit string that indicates a check was done with respect to said reward-payment-was-approved bit string”.

Furthermore, in the present embodiment, more than one check-was-done bit string are stored, the number M, which is a number indicating how many check-was-done bit strings are stored, is counted with respect to each affiliate partner site, and these are included in a market-data bit string.

In the present invention, however, for example, it is possible to store one check-was-done bit string with respect to one affiliate partner site and include the check-was-done bit strings for each affiliate partner sites in a market-data bit string. As described above, in this case, a check-was-done bit string with respect to a certain affiliate partner site indicates how many times Affiliate Server 10 receives an check-notifying bit string from Advertising Client Server 21 with respect to the certain affiliate partner site by itself.

Furthermore, in the present invention, it is possible to count the number N, which is a number indicating how many reward-payment-was-approved bit strings are stored, and the number M, which is a number indicating how many check-was-done bit strings are stored, and include the bit string that indicates the number calculated by four arithmetic operations of N, M or the bit string that indicates a graph contrasting N with M in a market-data bit string.

All of these structures are included in the term “generating a market-data bit string that indicates market data by using said stored check-was-done bit string”.

Note that it is possible to transmit reward-payment-approval-notifying bit strings from Advertising Client Server 21 to Affiliate Server 10 based on the event such as an reservation or an request for documents, while, in the above embodiment, reward-payment-approval-notifying bit strings are transmitted from Advertising Client Server 21 to Affiliate Server 10 based on the event such as that goods or services is purchased.

Note that the present invention defines not only more than 2-bit but also 1-bit as “bit string”.

### Example 1

Next, the example 1 of the present invention is described. In the example 1, Affiliate System 1 in which Affiliate Partner Site A and Affiliate Partner Site B exist is considered. Now assume that the check-notifying bit string means that a cancellation occurs after approving a payment of a reward. And assume that regarding Affiliate Partner Site A, N, which is a number of records in which reward-payment-was-approved bit strings are stored, is “100” and M, which is a number of records in which check-was-done bit strings are stored, is “90”. Further assume that regarding Affiliate Partner Site B, N, which is a number of records in which reward-payment-was-approved bit strings are stored, is “80” and M, which is a number of records in which check-was-done bit strings are stored, is “50”. And assume that the market-data bit string includes the bit string that indicates N and M with respect to each Affiliate Partner Site A, B.

According to the example 1, when comparing Affiliate Partner Site A and Affiliate Partner Site B, it is understood at Advertising Client Terminal 22 that Affiliate Partner Site A has better performance in sales than Affiliate Partner Site B. however, it is possible to decide that the computer users viewing Affiliate Partner Site B are good customers for the advertising client in the term of the number of the cancellation.

Thus, in the example 1, the advertising client excludes Affiliate Partner Site A from the network composition of Advertising Client Server 21. As a result, the advertising client, afterward, does not have to pay wasteful advertising rewards to the affiliate partner of Affiliate Partner Site A.

### Comparison Example 1

The same case as the above example 1 is considered, excepting that the network of the advertising client is constructed based on the performances of affiliate partner sites. In the comparison example 1, Affiliate Partner Site B is excluded from the network of the advertising client because of the reason such as a misunderstanding as that: if the performance is good, the number of cancellation is small. As a result, the advertising client has to keep paying wasteful advertising rewards to Affiliate Partner Site A.

### Example 2

Next, the example 2 of the present invention is described. In the example 2, Affiliate System 1 in which Affiliate Partner Site A and Affiliate Partner Site B exist is considered. Now assume that the check-notifying bit string means that a repeat purchase occurs after approving a payment of a reward. Further assume that regarding Affiliate Partner Site A, N, which is a number of records in which reward-payment-was-approved bit strings are stored, is “100” and M, which is a number of records in which check-was-done bit strings are stored, is “10”. Further assume that regarding Affiliate Partner Site B, N, which is a number of records in which reward-payment-was-approved bit strings are stored, is “80” and M, which is a number of records in which check-was-done bit strings are stored, is “50”. And assume that the market-data bit string includes the bit string that indicates N and M with respect to Affiliate Partner Site A, B.

According to the example 2, when comparing Affiliate Partner Site A and Affiliate Partner Site B, it is understood at Advertising Client Terminal 22 that Affiliate Partner Site A has better performance in sales than Affiliate Partner Site B. however, it is possible to decide that the computer users viewing Affiliate Partner Site B are good customers for the advertising client in the term of the number of the repeat purchase.

Thus, in the example 2, the advertising client excludes Affiliate Partner Site A from the network composition of Advertising Client Server 21. As a result, the advertising client, afterward, does not have to pay wasteful advertising rewards to the affiliate partner of Affiliate Partner Site A.

### Comparison Example 2

The same case as the above example 2 is considered, excepting that the network of the advertising client is constructed based on the performances of affiliate partner sites. In the comparison example 2, Affiliate Partner Site B is excluded from the network of the advertising client because of the reasons such as a misunderstanding as that: if the performance is better, the number of repeat purchase is bigger. As a result, the advertising client has to keep paying wasteful advertising rewards to Affiliate Partner Site A.

The embodiment and the examples of the present invention were described above. However, these descriptions represent one example of the present invention. Thus, the present invention is not limited to these descriptions.

What is claimed is:

1. An affiliate system, comprising:
an affiliate device; and
an advertising client device;
wherein said affiliate device and said advertising client device are connected with a network, and
said affiliate device:
storing a reward-payment-was-approved bit string that indicates a payment of a reward was approved if received a reward-payment-approval-notifying bit string that notifies of an approval of paying a reward for an affiliate partner from said advertising client device;
storing a check-was-done bit string that indicates a check was done with respect to said reward-payment-was-approved bit string if received a check-notifying bit string that notifies of checking with respect to said reward-payment-was-approved bit string from said advertising client device;
generating a market-data bit string that indicates market data by using said stored check-was-done bit string if received a market-data-disclosure-requesting bit string that requests for disclosure of said market-data bit string; and
sending said generated market-data bit string to said advertising client device.

2. The affiliate system of claim 1, wherein said affiliate device, for an affiliate partner site, does not perform or suspends at least one of an advertisement-disclosing processing, a redirect processing, and a storing processing of said reward-payment-was-approved bit string with respect to said advertising client device if received from said advertising client device a network-composition-modification-notifying bit string that notifies of excluding said affiliate partner site from said advertising client device's network composition based on said market-data bit string.

3. An affiliate device connected to an advertising client device with a network, comprising:
means for storing a reward-payment-was-approved bit string that indicates a payment of a reward was approved if received a reward-payment-approval-notifying bit string that notifies of an approval of paying a reward for an affiliate partner from said advertising client device;
means for storing a check-was-done bit string that indicates a check was done with respect to said reward-payment-was-approved bit string if received a check-notifying bit string that notifies of checking with respect to said reward-payment-was-approved bit string from said advertising client device;
means for generating a market-data bit string that indicates market data by using said stored check-was-done bit string if received a market-data-disclosure-requesting bit string that requests for disclosure of said market-data bit string; and
means for sending said generated market-data bit string to said advertising client device.

4. The affiliate device of claim 3, wherein the affiliate device, for an affiliate partner site, does not perform or suspends at least one of an advertisement-disclosing processing, a redirect processing, and a storing processing of said reward-payment-was-approved bit string with respect to said advertising client device if received from said advertising client device a network-composition-modification-notifying bit string that notifies of excluding said affiliate partner site from said advertising client device's network composition based on said market-data bit string.
